(19) United States
(12) Patent Application Publication
(10) Pub. No.: US 2026/0330567 A1
(43) Pub. Date: Oct. 22, 2026

(54) SYSTEM

(71) Applicant: SoftBank Group Corp., Tokyo (JP)

(72) Inventor: Kensuke FUKUSHIMA, Tokyo (JP)

(73) Assignee: SoftBank Group Corp., Tokyo (JP)

(21) Appl. No.: 19/649,126

(22) Filed: Apr. 16, 2026

(30) Foreign Application Priority Data
Apr. 22, 2025 (JP) 2025-070931

(51) Int. Cl. G06Q 40/08

(52) U.S. Cl. CPC G06Q 40/08221; G06Q 40/09

(57) ABSTRACT

The present invention relates to a dynamic pricing system for automobile insurance premiums that multilaterally and in real time analyzes driving behavior data, vehicle state data, and road environment data acquired by an in-vehicle sensor and Telematics technology using a generative AI, quantitatively evaluates a risk for each driver, thereby dynamically calculating an insurance premium, and automatically applying a discount incentive to a safe driver and a surcharge to a high-risk driver. This simultaneously realizes a reduction in an accident rate, a reduction in an insurance payout amount, an improvement in customer satisfaction, and an improvement in profitability of an insurance company.

### CROSS-REFERENCE TO RELATED APPLICATION

The present application claims priority to and incorporates by reference the entire contents of Japanese Patent Application No. 2025-070931 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a complex problem such as that the current automobile insurance premium structure is uniformly set mainly based on static attribute information such as the driver's age and mileage, and cannot sufficiently reflect dynamic and multilateral risk factors such as actual driving behavior, vehicle state, and road environment, resulting in a lack of appropriate incentives for safe drivers and a failure to ensure fairness in the insurance premium burden with high-risk drivers; that the profitability of insurance companies is squeezed by a persistently high accident rate and an increase in insurance payout amounts; and further, a decrease in customer satisfaction caused by the fact that customers cannot enjoy reasonable and convincing insurance premiums according to their own driving behavior. In order to solve these problems, an object of the present invention is to simultaneously realize a reduction in the accident rate, a reduction in the insurance payout amount, an improvement in customer satisfaction, and an improvement in the profitability of the insurance company by analyzing diverse driving data acquired by in-vehicle sensors and Telematics technology in real time and with high accuracy by a generative AI, quantitatively evaluating a driving risk, dynamically calculating an insurance premium, and applying a discount incentive to a safe driver and an appropriate surcharge to a high-risk driver.

### SUMMARY OF THE INVENTION

A means for solving the problem according to the present invention is to provide a configuration comprising: a data acquisition unit configured to collect driving behavior data, vehicle state data, and road environment data acquired from an in-vehicle sensor in real time; an evaluation unit configured to analyze a plurality of types of data obtained from the data acquisition unit by a generative AI and multilaterally and quantitatively evaluate a driving risk for each driver; and an insurance premium calculation unit configured to accumulate risk evaluation results by the evaluation unit and past driving history data over a long period of time, dynamically calculate an insurance premium based on a risk evaluation model continuously optimized by a machine learning model, and automatically apply a discount or surcharge incentive according to a risk profile of the driver, wherein the evaluation unit is configured to multilaterally analyze a plurality of risk factors such as sudden acceleration, sudden braking, sudden steering, speeding, bad weather, and bad road surface in driving behavior; and the insurance premium calculation unit is configured to calculate the insurance premium according to the driving risk that fluctuates in real time, and further automate a settlement process of an insurance contract using a smart contract technology.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

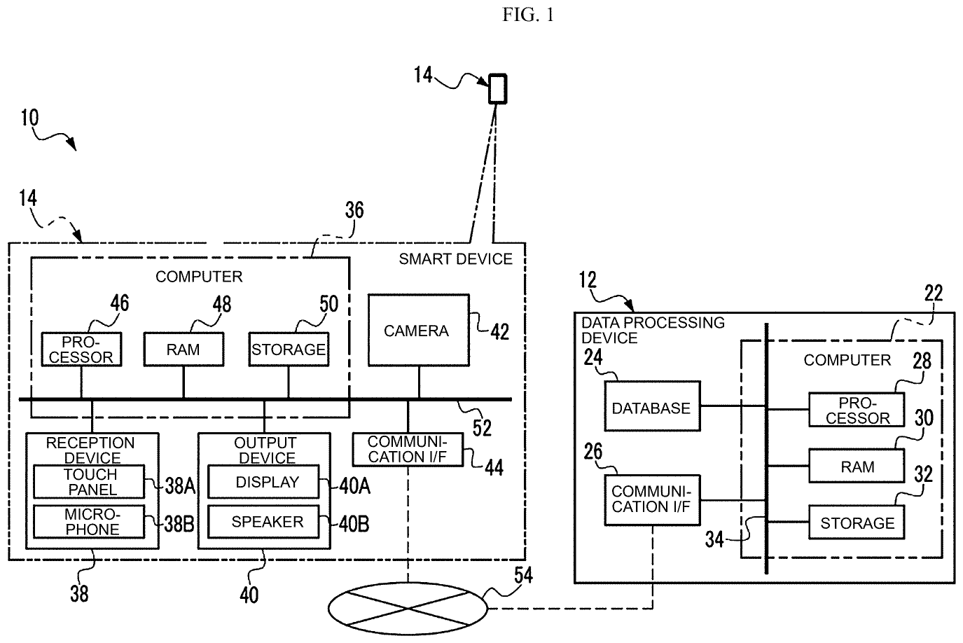

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

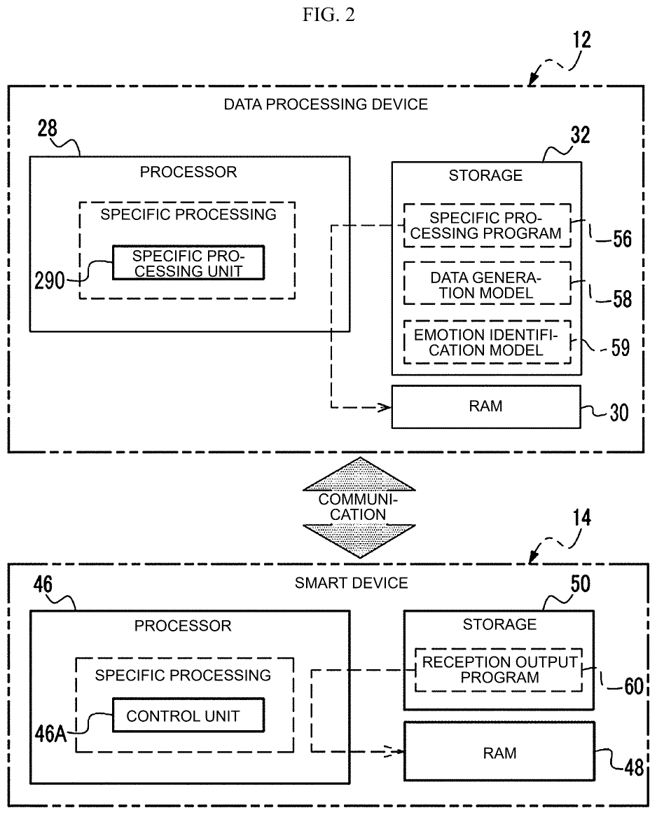

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### (Example 1)

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. The dynamic pricing system for automobile insurance premiums of the present invention has functions divided between a terminal and a server, and the terminal is realized by an in-vehicle device, a smartphone, or the like mounted on a vehicle, and the server is realized by a cloud computing environment, a data center, or the like. Specifically, the present system adopts an edge computing architecture. The present terminal includes an edge inference processor. The present server includes a distributed processing cluster. The present system executes initial data processing on the terminal side. The present system executes an advanced machine learning model on the server side. The present system suppresses consumption of a communication band between the terminal and the server. The present system minimizes the influence of network delay. The present system improves real-time performance. The present system realizes optimal allocation of computational resources. The present system is applied to a dynamic pricing field of automobile insurance. The present system is applied to a fleet management field. The present system is applied to a data collection field of connected cars. The present system overcomes physical constraints of hardware. The present system ensures scalability. The present system improves availability of the entire system. The present system localizes an influence range when a failure occurs. The present system adopts a redundant configuration. The present system maintains data consistency. The present system uses a secure communication protocol. The present system executes end-to-end encryption. The present system strengthens privacy protection. The present system reduces a risk of information leakage. The present system satisfies compliance requirements. The present system records an audit log. The present system ensures transparency of the system. The present system improves efficiency of operation and maintenance. The present system executes continuous integration and deployment. The present system automates software updates. The present system applies the latest security patch. The present system manages the entire life cycle of the system. The present system receives a state vector of the entire system as input data. The present state vector is a 100-dimensional floating-point number array. Elements of the present state vector include a CPU usage rate and memory consumption of each node. A normalization process is executed as preprocessing of the present state vector. A specific example of the present state vector is a numerical value indicating a decrease in a remaining battery level of the terminal. Another specific example of the present state vector is a numerical value indicating an increase in a communication load of the server. The present system generates a resource allocation optimization command as output data. The present output data is a structured control instruction format. Each value of the present output data indicates an allocation amount for a specific resource. A specific example of the present output data is a command instructing a processing transition to a specific node. Another specific example of the present output data is a command instructing termination of an unnecessary process. The present system inputs the output data to a subsequent orchestrator module. The present system controls start and stop of a container using the output data. The present system executes a load balancing process based on the output data. The present system realizes autonomous system operation without human intervention. The present system functions as a fundamental technology in an InsurTech field.

First, a configuration on the terminal side will be described. The terminal is equipped with a wide variety of sensors such as an acceleration sensor, a gyro sensor, a GPS module, a CAN data acquisition device from a vehicle control system, an in-vehicle camera, a microphone, a temperature sensor, a humidity sensor, a tire pressure sensor, an illuminance sensor, an inside/outside air pressure sensor, and a driver's biometric sensor (a heart rate monitor, a pulse monitor, a face recognition camera, etc.). From these sensors, a very wide variety of driving behavior data, vehicle state data, and road environment data are acquired in real time, such as sudden acceleration, sudden deceleration, sudden steering, speeding, long-time driving, idling time, lane departure, inter-vehicle distance, ignoring traffic lights, night driving, driving in bad weather, driving in traffic jams, driving without lights, drowsy driving, suspected drunk driving, driving while operating a smartphone, sudden stop of the vehicle, sudden start, sudden turn, tire pressure drop, brake pad wear, engine abnormality, battery abnormality, low oil level, vehicle failure diagnosis information, abnormal in-vehicle temperature, abnormal outside temperature, road surface temperature, road surface freezing, rainfall/snowfall conditions, fog, strong wind, road construction information, accident-prone point information, road congestion degree, traffic regulation information, behavior of surrounding vehicles, pedestrian darting out, and animal darting out. Specifically, the present terminal includes a multi-sensor fusion module. The present module converts an analog signal from each sensor into a digital time-series tensor. The present module synchronizes a sampling rate. The present module generates a high-dimensional feature vector. The present system interpolates data loss. The present system reduces noise. The present system captures a minute change in driving behavior. The present system is applied to a fleet management field. The present terminal receives a raw data stream from each sensor as input data. The present raw data stream is a variable-length time-series array. Elements of the present raw data stream include a voltage value and a pulse signal. The present terminal executes low-pass filtering as preprocessing of the raw data stream. A specific example of the present raw data stream is a sudden acceleration spike due to a step on a road surface. Another specific example of the present raw data stream is an interruption of a GPS signal in a tunnel. The present terminal generates a synchronized multi-dimensional sensor tensor as output data. The present output data is a matrix of floating-point numbers aligned on a time axis. Each value of the present output data indicates an observation value of each sensor at a specific time. A specific example of the present output data is a pair of speed and acceleration at time zero. Another specific example of the present output data is a pair of a steering angle and a yaw rate at time one. The present terminal inputs the output data to a subsequent feature extraction module. The present terminal executes an abnormality detection process using the output data. The present terminal executes a data buffering process based on the output data. The present system eliminates a time lag between heterogeneous sensors. The present system improves inference accuracy of a subsequent machine learning model. The present system is applied to an environment recognition field of autonomous vehicles. The present system detects a sensor failure at an early stage. The present system activates a fail-safe mechanism. The present system ensures safety of the vehicle. The present system enables real-time processing on the edge side. The present system realizes autonomous judgment independent of communication delay. The present system is applied to an advanced driving assistance system field.

On the terminal side, these data are temporarily accumulated and transmitted to the server, for example, every 1 second, every 5 seconds, every 1 minute, or at every event trigger (when sudden braking occurs, when an accident occurs, etc.). Before transmission, preprocessing such as noise removal, data normalization, abnormal value detection, time-series shaping, data compression, encryption, and data anonymization is performed. For example, drift correction of GPS data, spike removal of acceleration data, abnormal value filtering of CAN data, privacy masking of camera images (automatic blurring of faces and license plates), noise canceling of audio data, and the like are executed. Specifically, the present terminal executes an edge-side preprocessing pipeline. The present pipeline corrects drift using a Kalman filter. The present pipeline removes noise in a frequency domain using a fast Fourier transform. The present pipeline detects an abnormal value using an autoencoder. The present pipeline compresses data into a low-dimensional latent vector. The present terminal protects data using an encryption module. The present system significantly reduces a calculation load on the server. The present system realizes secure data transmission. The present system is applied to a data collection field of connected cars. The present terminal receives a synchronized multi-dimensional sensor tensor as input data. The present tensor is a two-dimensional array of a time axis and a sensor type. Elements of the present tensor include unprocessed observation values. The present terminal executes linear interpolation of missing values as preprocessing of the tensor. A specific example of the present tensor is acceleration data on which noise is superimposed. Another specific example of the present tensor is an in-vehicle camera image in which a pedestrian's face is reflected. The present terminal generates a compressed and encrypted payload as output data. The present output data is a data stream in a binary format. Each bit of the present output data has an information-theoretically optimized representation. A specific example of the present output data is an image feature vector subjected to privacy masking. Another specific example of the present output data is smoothed time-series data from which an abnormal value is removed. The present terminal inputs the output data to a subsequent communication module. The present terminal constructs a transmission queue to the server using the output data. The present terminal executes a retransmission control process based on the output data. The present system maximizes utilization efficiency of a communication band. The present system realizes data handling compliant with personal information protection legislation. The present system is applied to a Mobility as a Service field. The present terminal executes an event-driven transmission logic. The present terminal triggers immediate transmission when detecting an acceleration change exceeding a threshold value. The present terminal reduces a data transmission frequency during steady driving. The present system optimizes communication costs. The present system ensures that important incident data reaches the server. The present system is applied to an accident investigation and cause identification field. The present terminal exchanges a session key using a public key cryptography method. The present terminal encrypts a payload using a common key cryptography method. The present system prevents a man-in-the-middle attack. The present system ensures data confidentiality.

On the server side, an enormous amount of data transmitted from the terminal is received, and a multi-stage analysis process by a generative AI is performed. The generative AI is configured by combining, for example, a large language model, a time-series data generation model, an image generation model, an abnormality detection model, a reinforcement learning model, a self-supervised learning model, a transfer learning model, a multimodal AI model, and the like. For example, the time-series data generation model analyzes a continuous change pattern of driving behavior and predicts future risk behavior from a past driving history. For example, the image generation model automatically determines weather (clear weather, rain, snow, fog, nighttime, etc.) and road surface conditions (dry, wet, frozen, falling objects, etc.) from an in-vehicle camera image, and extracts a dangerous driving environment. For example, an audio generation model analyzes audio data acquired from an in-vehicle microphone and estimates a state of the driver such as fatigue, drowsiness, distraction, anger, and stress. For example, the multimodal AI model integrally analyzes these different types of data and generates a comprehensive risk profile of the driver. Specifically, the present server executes a multimodal neural network based on a transformer architecture. The present server receives a multi-dimensional time-series tensor as input data. The present time-series tensor has a dimensionality of 100 rows and 3 columns. Elements of the present time-series tensor include numerical data of a speed, an acceleration, and a steering angle of the vehicle. The present server executes zero averaging and variance normalization as preprocessing of the time-series tensor. A specific example of the present time-series tensor is rapid negative acceleration data during sudden braking. Another specific example of the present time-series tensor is fluctuation data of a steering angle during a lane change. The present server receives an image tensor as input data. The present image tensor has a dimensionality of 224 pixels vertically, 224 pixels horizontally, and 3 channels. Elements of the present image tensor include red, green, and blue pixel values. The present server executes resizing and cropping as preprocessing of the image tensor. A specific example of the present image tensor is a field-of-view image through a windshield in rainy weather. Another specific example of the present image tensor is a headlight image of an oncoming vehicle at night. The present server receives an audio spectrogram as input data. The present audio spectrogram is a two-dimensional array of frequency and time. The present server applies a noise removal filter as preprocessing of the audio spectrogram. A specific example of the present audio spectrogram is audio data of a driver's sigh. Another specific example of the present audio spectrogram is audio data of a conversation with a passenger. The present server maps these input data to a common high-dimensional latent space. The present server calculates a correlation between respective modalities using a cross-attention mechanism. The present server generates a risk probability distribution as output data. The present output data is a one-dimensional array of floating-point numbers indicating an occurrence probability of each risk factor. Each value of the present output data indicates a high possibility that a specific risk will become apparent. A specific example of the present output data is a numerical value indicating that an accident occurrence probability is 0.85. Another specific example of the present output data is a numerical value indicating that a drowsy driving probability is 0.92. The present server inputs the output data to a subsequent risk evaluation module. The present server executes a threshold determination process using the output data. The present server executes a branching process to another module based on the output data. The present system realizes highly accurate analysis independent of human intuition. The present system is applied to an intelligent transport system field. The present system dramatically improves risk prediction accuracy in a complex environment. The present system complements a blind spot of a single sensor by integrating a plurality of pieces of sensor information. The present system significantly reduces a false positive rate. The present system optimizes calculation efficiency. The present system improves an inference speed using a parallel arithmetic processor. The present system enables real-time danger detection.

The generative AI multilaterally combines respective data of driving behavior, a vehicle state, and a road environment to calculate a risk score for each driver. For example, when sudden acceleration or sudden deceleration occurs frequently, when driving at night or in bad weather is frequent, when poor maintenance of the vehicle is detected, when dangerous behavior is frequent in traffic jams or accident-prone points, when the driver is driving while operating a smartphone, when drowsy driving or drunk driving is suspected, when a safety device of the vehicle (automatic braking, lane departure warning, etc.) operates frequently, and the like, a plurality of risk factors are integrally evaluated, and a risk score is dynamically generated. For example, when the driver shows driving behavior similar to a pattern in which an accident occurred in the past, the generative AI automatically extracts the relevance and automatically sets the risk score high. For example, when safe driving continues for a certain period of time, the generative AI learns the tendency and automatically reduces the risk score. Specifically, the present server calculates a risk score using a multilayer perceptron. The present server receives a risk probability distribution and a past history vector as input data. The present history vector is a 50-dimensional floating-point number array. Elements of the present history vector include the number of past violations and an accident-free period. The present server executes batch normalization as preprocessing of the input data. A specific example of the present input data is distribution data indicating that a sudden acceleration probability is high. Another specific example of the present input data is a vector indicating a history of causing a rear-end collision in the past. The present server generates a risk score that is a continuous value from 0 to 100 as output data. The present output data is a single scalar value. The value of the present output data indicates a comprehensive danger level of the driver. A specific example of the present output data is a numerical value of 95 indicating that it is extremely dangerous. Another specific example of the present output data is a numerical value of 15 indicating that it is safe. The present server generates structured data indicating a contribution degree of a risk factor as output data. The present structured data is a set of key-value pairs. A specific example of the present structured data is data indicating that sudden acceleration contributes 40 percent. Another specific example of the present structured data is data indicating that bad weather contributes 60 percent. The present server optimizes weights of the model using a gradient descent method. The present server minimizes a prediction error using a cross-entropy error function. The present server inputs the output risk score to a subsequent threshold determination module. The present server executes a branching process of a surcharge and a discount of an insurance premium using the output data. The present server executes a warning message generation process for the driver based on the output data. The present system immediately follows a behavioral change of the driver. The present system is applied to a personalized insurance product development field. The present system completely automates a risk quantification process. The present system eliminates bias by a human assessor. The present system ensures fairness and transparency of evaluation. The present system reflects dynamic risk fluctuation in a price in real time. The present system improves financial soundness of an insurance company. The present system promotes safe driving with an economic incentive. The present system contributes to a reduction in traffic accidents in society as a whole.

In addition, the generative AI accumulates past accident data and driving history data as a long-term memory, and utilizes them for continuous learning and optimization of a machine learning model. For example, it refers to accident data and a driving history from several years ago, and immediately issues a warning when a similar risk pattern appears. For example, it detects a behavioral change of the driver (such as suddenly turning to safe driving, or conversely, an increase in risk behavior), and automatically corrects a risk evaluation model. For example, the AI model is automatically learned and optimized according to an environmental change such as a change in social traffic rules, introduction of new road infrastructure, a change in weather patterns due to climate change, and evolution of vehicle technology (addition of an autonomous driving function, etc.). Specifically, the present server constructs a long-term memory using a vector database. The present server stores past driving history data as a high-dimensional vector. The present server compares current driving data with past data using cosine similarity. The present server dynamically adjusts an attention weight when detecting a similar pattern. The present server continuously updates the model using an online learning algorithm. The present server applies an experience replay method to prevent catastrophic forgetting. The present system improves adaptability of the model to an environmental change. The present system is applied to a safety evaluation field of autonomous vehicles. The present server receives a current driving feature vector and a past history vector as input data. The present feature vector is a 256-dimensional floating-point number array. Elements of the present feature vector include a latent representation of the latest driving behavior. The present server executes dimensionality reduction as preprocessing of the input data. A specific example of the present input data is a vector indicating meandering driving currently in progress. Another specific example of the present input data is a history vector of a slip accident that occurred in winter three years ago. The present server generates a similarity score as output data. The present output data is a continuous value from 0 to 1. The value of the present output data indicates similarity between current and past situations. A specific example of the present output data is a numerical value of 1.0 indicating a complete match with a past accident pattern. Another specific example of the present output data is a numerical value of 0.1 indicating no relevance at all. The present server inputs the output data to a subsequent warning generation module. The present server determines a retraining trigger of the model using the output data. The present server executes a weight update process of an attention mechanism based on the output data. The present system accurately tracks characteristics of the driver that change over time. The present system reflects a macro environmental change in parameters of the model. The present system prevents obsolescence of the model. The present system realizes continuous accuracy improvement. The present system is applied to a data-driven risk management field. The present system directly utilizes past lessons for future accident prevention. The present system automates a cycle of knowledge accumulation and reuse.

On the server side, an insurance premium calculation unit dynamically calculates an insurance premium based on a risk evaluation result by the generative AI. For example, the insurance premium is automatically adjusted according to a risk profile for each driver, such as applying a 20 percent discount from a basic insurance premium when a risk score is less than a certain value, and applying a surcharge when the risk score is high. For example, when the driver continues safe driving, an insurance premium for the next month is automatically discounted. For example, when an accident or a violation occurs, the insurance premium is immediately recalculated and a surcharge is applied. For example, in the case of a corporate vehicle manager, risk scores of a plurality of vehicles can be aggregated to optimize the overall insurance premium. Specifically, the present server executes an insurance premium calculation module integrating a rule-based engine and a machine learning model. The present module receives a risk score and a contractor attribute vector as input data. The present attribute vector is a 10-dimensional integer array. Elements of the present attribute vector include an age, a vehicle type, and a contract grade. The present module executes one-hot encoding of a categorical variable as preprocessing of the input data. A specific example of the present input data is a numerical value indicating that the risk score is 20. Another specific example of the present input data is a vector indicating that the contractor is a new subscriber in their twenties. The present module generates numerical data indicating a final insurance premium as output data. The present output data is an integer value having a currency unit. The value of the present output data indicates a next billing amount. A specific example of the present output data is an insurance premium after a discount of 5,000 yen is applied. Another specific example of the present output data is an insurance premium after a surcharge of 10,000 yen is applied. The present module generates text data indicating a basis for a discount rate as output data. The present text data is a character string in a natural language. A specific example of the present text data is a character string indicating that it is a discount due to continuation of safe driving. The present module transmits the calculated insurance premium to a subsequent billing system. The present module executes an automatic generation process of an invoice using the output data. The present module executes a notification email transmission process to a customer based on the output data. The present system realizes fair pricing according to a risk. The present system is applied to a dynamic pricing field. The present system calculates a complex insurance premium structure at high speed and accurately. The present system updates a price not by batch processing but by real-time stream processing. The present system enhances market competitiveness. The present system improves a customer's sense of satisfaction. The present system solves a total optimization problem in a fleet contract using linear programming. The present system contributes to cost reduction for corporate customers. The present system seamlessly integrates an actuarial model and an AI prediction model.

Furthermore, by using a smart contract technology, a settlement process of an insurance contract and an incentive granting process are automated. For example, automated processing is realized such that a discount incentive is automatically granted when safe driving continues for a certain period of time, an insurance payout process is automatically started when an accident occurs, and an insurance premium is immediately recalculated when the driver shows new risk behavior. For example, when the driver causes an accident, sensor data, an in-vehicle camera image, GPS position information, and the like at the time of occurrence of the accident are automatically transmitted to the server, and the generative AI analyzes an accident situation and automatically determines whether or not an insurance payout is possible and an amount thereof. Specifically, the present server executes a smart contract using a distributed ledger technology. The present server deplones contract conditions as a program code on a blockchain network. The present server calls a state transition function triggered by a fluctuation of a risk score. The present server prevents data falsification using a cryptographic hash function. The present server approves a transaction using a consensus building algorithm. The present system eliminates an intermediary and improves a processing speed. The present system is applied to an automatic insurance payout field. The present server receives a sensor data tensor at the time of occurrence of an accident as input data. The present tensor includes time-series data before and after a collision. Elements of the present tensor are numerical values indicating a rapid change in a three-axis acceleration and an angular velocity. The present server executes verification of a digital signature as preprocessing of the input data. A specific example of the present input data is CAN data including an airbag deployment signal. Another specific example of the present input data is video data of a drive recorder capturing a moment of a collision. The present server generates an insurance payout determination flag and a payout amount as output data. The present output data is a combination of a Boolean value and an integer value. The value of the present output data indicates whether or not execution of a payout is possible and a specific remittance amount. A specific example of the present output data is a true value indicating payout permission and an amount of 500,000 yen. Another specific example of the present output data is a false value indicating payout rejection because it falls under an exemption reason. The present server inputs the output data to a subsequent crypto asset wallet module. The present server executes an issuance process of a remittance transaction using the output data. The present server executes a recording process to a distributed ledger based on the output data. The present system shortens a lead time from billing to payment from several days to several seconds. The present system prevents insurance fraud by an algorithm. The present system ensures transparency and self-executability of a contract. The present system realizes value transfer in a trustless environment. The present system is applied to a decentralized finance field. The present system verifies vulnerability of a smart contract in advance with a static analysis tool. The present system provides a secure execution environment.

On the terminal side, a user interface for providing feedback to the driver in real time is provided. For example, a current risk score, a fluctuation status of an insurance premium, an acquisition status of a safe driving incentive, a past driving history, safe driving advice by AI, and the like are displayed on a smartphone application or an in-vehicle display. For example, when sudden braking occurs frequently, a warning message such as “The risk score is increasing because there is a lot of sudden braking” is displayed to prompt improvement of driving behavior. For example, when safe driving continues for a certain period of time, an incentive notification such as “The insurance premium will be discounted because safe driving is continued” is performed. For example, when it is detected that the driver is driving while operating a smartphone, a warning such as “Operating a smartphone while driving is dangerous” is immediately displayed. Specifically, the present terminal executes a graphical user interface drawing engine. The present terminal parses a risk score and a warning message received from the server. The present terminal renders information on a screen in a layout that reduces a visual cognitive load of the driver. The present terminal outputs a warning message as audio using a speech synthesis module. The present terminal drives a tactile feedback device to transmit a warning to the driver. The present system effectively prompts a behavioral change of the driver. The present system is applied to a human-machine interface field. The present terminal receives a risk score and a text message transmitted from the server as input data. The present input data is structured data in a JSON format. Elements of the present input data include a numerical value of a score and a character string of a message. The present terminal executes a translation process into a local language as preprocessing of the input data. A specific example of the present input data is data indicating that a score has worsened to 80. Another specific example of the present input data is character string data warning of smartphone operation. The present terminal generates a drawing command to a display as output data. The present output data is an API call instruction group of a graphics library. Each value of the present output data indicates coordinates and color information on a screen. A specific example of the present output data is a drawing command for blinking the entire screen in red. Another specific example of the present output data is a drawing command for displaying a green check mark icon. The present terminal inputs the output data to a subsequent display driver. The present terminal executes an update process of a screen using the output data. The present terminal executes a synchronization process of audio output based on the output data. The present system optimizes an information presentation timing to prevent distraction during driving. The present system utilizes a head-up display so as not to divert the driver's line of sight from a road. The present system incorporates a gamification element to improve motivation for safe driving. The present system applies a nudge theory of behavioral economics to unconsciously guide to safe behavior. The present system is applied to a driver monitoring system field.

In addition, on the server side, it is possible to standardize Telematics data compliant with an ISO standard and integrally analyze data from a plurality of automobile manufacturers and in-vehicle sensor platforms. For example, even for data from different vehicle types or different sensor manufacturers, the generative AI automatically performs standardization and normalization of the data, and maintains accuracy of a risk evaluation model. For example, for a corporate vehicle manager who owns a plurality of vehicles, a dashboard capable of collectively managing a risk score and an insurance premium for each vehicle can be provided, and a driving tendency and a risk factor for each vehicle can be visualized. For example, it is also possible for a corporate manager to grasp risk behavior of a specific driver and utilize it for education and guidance. Specifically, the present server executes a data normalization pipeline. The present pipeline converts input data in different formats into a common schema. The present pipeline interpolates a missing value using a machine learning model. The present server generates a dashboard using a web application framework. The present server executes a graph drawing library for visualizing multi-dimensional data. The present server dynamically filters data according to an operation of an administrator. The present system facilitates data integration in a heterogeneous mixed environment. The present system is applied to a logistics fleet management field. The present server receives telematics data in heterogeneous formats as input data. The present input data includes various formats such as XML and CSV. Elements of the present input data include a sensor value recorded in a manufacturer's unique unit system. The present server executes unified conversion of a unit system as preprocessing of the input data. A specific example of the present input data is speed data recorded in miles per hour. Another specific example of the present input data is temperature data recorded in Fahrenheit. The present server generates a standardized tensor as output data. The present output data is a multi-dimensional array unified into the International System of Units. Each value of the present output data is a normalized numerical value that can be directly processed by the model. A specific example of the present output data is an array of speeds converted to kilometers per hour. Another specific example of the present output data is an array of temperatures converted to Celsius. The present server inputs the output data to a subsequent generative AI analysis module. The present server executes a graph drawing process of a dashboard using the output data. The present server executes a storage process in a database based on the output data. The present system eliminates vendor lock-in. The present system ensures interoperability of platforms. The present system supports construction of a large-scale data lake. The present system provides a visual interface that allows an administrator to intuitively grasp a situation. The present system enables drill-down analysis. The present system identifies a root cause of dangerous behavior of a specific driver. The present system supports formulation of a safety education program. The present system contributes to compliance management of a company.

Furthermore, the generative AI flexibly adapts to behavioral changes of the driver and new risk factors. For example, the AI model is automatically learned and optimized according to environmental changes such as changes in social traffic rules, introduction of new road infrastructure, changes in weather patterns due to climate change, and evolution of vehicle technology (addition of autonomous driving functions, etc.). For example, when a driving behavior that was not considered a risk factor in the past is newly associated with an accident risk, the generative AI automatically extracts the association and corrects the risk evaluation model. For example, when the AI detects a new type of traffic accident or violation pattern, it can immediately update a risk evaluation algorithm and reflect it to all users. Specifically, the server executes a reinforcement learning agent. The agent updates a policy function so as to maximize a reward signal from the environment. The server applies a clustering algorithm of unsupervised learning to detect a new risk factor. The server identifies an unknown accident pattern using an abnormality detection model. The server retrains the model using the identified pattern as new learning data. The system improves the robustness of the system against unknown threats. The system is applied to the field of next-generation mobility services. The server receives a new risk factor vector as input data. The vector is a data point in a high-dimensional feature space. The elements of the vector include a combination of sensor values that have not been observed so far. The server executes dimensionality reduction by principal component analysis as preprocessing of the input data. A specific example of the input data is sensor data indicating a near miss with a new type of electric kickboard. Another specific example of the input data is an image feature amount indicating sudden poor visibility due to a guerrilla rainstorm. The server generates updated model weights as output data. The output data is a parameter group of a neural network. Each value of the output data is a weighting coefficient adjusted so as to be able to recognize a new risk pattern. A specific example of the output data is a change in a bias value of a specific hidden layer. Another specific example of the output data is an update of a weight matrix of an attention mechanism. The server deploys the output data to a subsequent inference engine. The server executes a model synchronization process of all nodes using the output data. The server executes an archiving process of an old model based on the output data. The system automatically copes with concept drift. The system eliminates the need for manual model tuning by a human data scientist. The system completely automates model lifecycle management. The system always provides a risk evaluation optimized for the latest traffic environment. The system is applied to the field of OTA updates for autonomous driving systems. The system realizes a self-evolving system that follows changes in social infrastructure.

As described above, in the embodiment of the present invention, by adopting a configuration in which the terminal side performs collection and preprocessing of sensor data and provision of a user interface, and the server side realizes data analysis, risk evaluation, insurance premium calculation, smart contract processing, data standardization, provision of a dashboard for corporations, and the like by the generative AI, it is possible to respond to diverse needs of individual automobile owners, corporate vehicle managers, the insurance industry, automobile manufacturers, and the like, and simultaneously realize a reduction in an accident rate, a reduction in an insurance payout amount, an improvement in customer satisfaction, and an improvement in profitability of an insurance company. Specifically, the system optimizes computational resources through cooperative processing between an edge device and a cloud server. The system constructs an end-to-end processing pipeline from data collection to insurance premium calculation. The system manages a data flow between respective modules using an asynchronous messaging queue. The system adopts a microservices architecture to ensure scalability. The system improves the availability of the entire system. The system is applied to the InsurTech field. The system receives a state vector of the entire system as input data. The state vector is a numerical array indicating an operating status of each subsystem. The elements of the state vector include the number of retentions in a queue and an error rate. The system executes calculation of a moving average as preprocessing of the input data. A specific example of the input data is data indicating access concentration in a specific time zone. Another specific example of the input data is data indicating communication disruption from some sensor nodes. The system generates a resource allocation optimization command as output data. The output data is a control instruction for an orchestrator. Each value of the output data indicates the number of replicas of a container and an allocated memory amount. A specific example of the output data is a command instructing scale-out of an inference container. Another specific example of the output data is a command instructing detachment of a failed node. The system inputs the output data to a subsequent container management platform. The system executes an auto-scaling process using the output data. The system executes a self-healing process based on the output data. The system brings about an improvement in computer technology itself, not just operational efficiency. The system dramatically enhances the fault tolerance of a distributed system. The system provides an architecture for processing an enormous amount of stream data without delay. The system contributes to solving data-driven social issues. The system maximizes the value of the entire mobility ecosystem. The system provides a technical foundation for realizing a sustainable traffic society.

### (System Configuration)

The system according to the present embodiment comprises a data acquisition unit, a data preprocessing unit, a data transmission unit, a generative AI analysis unit, a risk evaluation unit, an insurance premium calculation unit, an incentive provision unit, a smart contract processing unit, a user interface unit, a data long-term memory unit, a corporate management dashboard unit, and a data standardization unit. The data acquisition unit acquires driving behavior data, vehicle state data, and road environment data in real time from a wide variety of sensors mounted on a vehicle, such as an acceleration sensor, a gyro sensor, a GPS module, a CAN data acquisition device from a vehicle control system, an in-vehicle camera, a microphone, a temperature sensor, a humidity sensor, a tire pressure sensor, an illuminance sensor, an inside/outside air pressure sensor, and a driver's biometric sensor, for example, sudden acceleration, sudden deceleration, sudden steering, speeding, long-time driving, idling time, lane departure, inter-vehicle distance, ignoring traffic lights, night driving, driving in bad weather, driving in traffic jams, driving without lights, drowsy driving, suspected drunk driving, driving while operating a smartphone, sudden stop of the vehicle, sudden start, sudden turn, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall conditions, fog, strong wind, road construction information, accident-prone point information, road congestion degree, traffic regulation information, behavior of surrounding vehicles, pedestrian darting out, and animal darting out. The data preprocessing unit performs noise removal, data normalization, abnormal value detection, time-series shaping, data compression, encryption, data anonymization, and the like on the acquired data, and executes, for example, drift correction of GPS data, spike removal of acceleration data, abnormal value filtering of CAN data, privacy masking of camera images, and noise canceling of audio data. The data transmission unit transmits the preprocessed data to the server, for example, every 1 second, every 5 seconds, every 1 minute, or at every event trigger such as when sudden braking occurs or when an accident occurs. The generative AI analysis unit operates on the server and multilaterally and integrally analyzes the driving behavior data, the vehicle state data, and the road environment data by combining, for example, a large language model, a time-series data generation model, an image generation model, an abnormality detection model, a reinforcement learning model, a self-supervised learning model, a transfer learning model, a multimodal AI model, and the like. For example, the time-series data generation model analyzes a continuous change pattern of driving behavior and predicts future risk behavior from past driving history. For example, the image generation model automatically determines weather and road surface conditions from in-vehicle camera images and extracts a dangerous driving environment. For example, the audio generation model analyzes audio data acquired from an in-vehicle microphone and estimates states such as driver's fatigue, drowsiness, distraction, anger, and stress. For example, the multimodal AI model integrally analyzes these different types of data and generates a comprehensive risk profile of the driver. Based on the output of the generative AI analysis unit, the risk evaluation unit integrally evaluates a plurality of risk factors, for example, when sudden acceleration or sudden deceleration occurs frequently, when driving at night or in bad weather is frequent, when poor maintenance of the vehicle is detected, when dangerous behavior is frequent in traffic jams or accident-prone points, when the driver is driving while operating a smartphone, when drowsy driving or drunk driving is suspected, and when a safety device of the vehicle operates frequently, and dynamically generates a risk score for each driver. Based on the risk score of the risk evaluation unit, the insurance premium calculation unit automatically adjusts the insurance premium according to the risk profile for each driver, for example, by applying a 20 percent discount from a basic insurance premium when the risk score is less than a certain value, and applying a surcharge when the risk score is high. The incentive provision unit automatically provides a discount incentive when safe driving continues for a certain period of time, immediately applies a surcharge when an accident or a violation occurs, and dynamically adjusts the incentive according to a behavioral change of the driver. The smart contract processing unit automates a settlement process of an insurance contract and an incentive provision process, and for example, automatically starts an insurance payout process when an accident occurs, or immediately recalculates the insurance premium when the driver shows a new risk behavior. The user interface unit operates on the terminal and displays, for example, a current risk score, a fluctuation status of the insurance premium, an acquisition status of a safe driving incentive, past driving history, safe driving advice by AI, and the like on a smartphone application or an in-vehicle display, displays a warning message such as “The risk score is increasing because there is a lot of sudden braking” when sudden braking occurs frequently, provides an incentive notification such as “The insurance premium will be discounted because safe driving is continued” when safe driving continues for a certain period of time, and immediately displays a warning such as “Operating a smartphone while driving is dangerous” when it is detected that the driver is driving while operating a smartphone. The data long-term memory unit accumulates past accident data and driving history data over a long period of time, utilizes them for continuous learning and optimization of the generative AI, and for example, refers to accident data and driving history from several years ago, immediately issues a warning when a similar risk pattern appears, detects a behavioral change of the driver, and automatically corrects the risk evaluation model. The corporate management dashboard unit provides a dashboard capable of collectively managing a risk score and an insurance premium for each vehicle for a corporate vehicle manager who owns a plurality of vehicles, and for example, visualizes a driving tendency and a risk factor for each vehicle, grasps a risk behavior of a specific driver and utilizes it for education and guidance, and optimizes the overall insurance premium. The data standardization unit performs a standardization process on Telematics data compliant with an ISO standard, and for example, even if the data is from different vehicle models or different sensor manufacturers, the generative AI automatically performs standardization and normalization of the data to maintain the accuracy of the risk evaluation model. Specifically, the system executes each component as an independent process using containerization technology. The system manages the lifecycle of a container using an orchestration tool. The system ensures real-time performance by using an interrupt process in the data acquisition unit. The system executes parallel computing using a graphics processing unit in the generative AI analysis unit. The system ensures interpretability of inference by using a decision tree ensemble model in the risk evaluation unit. The system utilizes a remote procedure call for communication between respective units. The system reduces the degree of coupling between modules. The system is applied to the field of large-scale telematics systems. The system receives status information of each unit as input data. The status information includes a health check result of each module. The elements of the status information include a response time and an error code. The system executes a log parsing process as preprocessing of the input data. A specific example of the input data is an error log indicating a database connection timeout. Another specific example of the input data is a warning log indicating that a memory usage rate has exceeded ninety percent. The system generates a system health score as output data. The output data is a numerical value indicating the health of the entire system. Each value of the output data indicates a normal operation probability of each subsystem. A specific example of the output data is a numerical value of one hundred indicating that the system is normal. Another specific example of the output data is a numerical value of seventy indicating that some functions are in a degenerate operation. The system inputs the output data to a subsequent monitoring dashboard. The system executes an alert issuing process using the output data. The system triggers execution of an automatic recovery script based on the output data. The system dramatically reduces an operational load in a complex system configuration. The system eliminates a single point of failure. The system configures a high availability cluster. The system provides a robust foundation supporting mission-critical insurance operations.

Specific examples of a prompt sentence to be read into the generative AI necessary for implementing the present invention include, for example, “Extract risk factors such as sudden acceleration, sudden deceleration, sudden steering, speeding, long-time driving, lane departure, ignoring traffic lights, night driving, driving in bad weather, driving in traffic jams, driving without lights, drowsy driving, suspected drunk driving, driving while operating a smartphone, sudden stop of the vehicle, sudden start, sudden turn, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall conditions, fog, strong wind, road construction information, accident-prone point information, road congestion degree, traffic regulation information, behavior of surrounding vehicles, pedestrian darting out, and animal darting out from the following time-series driving data, and calculate a risk score for each driver”, or “Estimate weather, road surface conditions, and states such as driver's fatigue, drowsiness, distraction, anger, and stress from in-vehicle camera images and audio data, perform a comprehensive risk evaluation, and reflect it in insurance premium calculation”, or “Utilize past accident data and driving history data as a long-term memory, immediately issue a warning when a similar pattern appears, and automatically correct a risk evaluation model”. Furthermore, for a corporate vehicle manager, a prompt such as “Integrate driving data of a plurality of vehicles and generate a dashboard capable of collectively managing a risk score and an insurance premium for each vehicle” is also used. Specifically, the server divides the prompt sentence into a token sequence using a natural language processing model. The server converts the token sequence into an embedding vector. The server supplies the embedding vector to an input layer of a transformer model. The server extracts a contextual dependency in the prompt using a self-attention mechanism. The server dynamically switches an internal inference path according to an instruction of the prompt. The server controls an output of the model using prompt engineering technology. The system makes it possible to process a complex task with a single model. The system is applied to the field of interactive AI assistants. The server receives a natural language text as input data. The text includes a task instruction and context information. The elements of the text are a sequence of words and punctuation marks. The server executes subword tokenization as preprocessing of the input data. A specific example of the input data is a character string instructing calculation of a risk score. Another specific example of the input data is a character string instructing generation of a dashboard. The server generates a high-dimensional embedding vector as output data. The output data is an array of floating-point numbers capturing a semantic representation of each token. Each value of the output data indicates a coordinate in a latent space. A specific example of the output data is a vector expressing a concept of sudden acceleration. Another specific example of the output data is a vector expressing a state of fatigue. The server inputs the output data to a subsequent transformer block. The server executes calculation of multi-head attention using the output data. The server generates a final task execution result based on the output data. The system realizes flexible task execution without depending on hard-coded rules. The system utilizes capabilities of zero-shot learning and few-shot learning. The system performs appropriate inference even for an unknown task. The system maximizes the versatility of the model. The system enables intuitive system control through a natural language interface.

### (Implementation Steps)

Step 1: Collection of Sensor Data Driving behavior data, vehicle state data, and road environment data such as sudden acceleration, sudden deceleration, sudden steering, speeding, long-time driving, idling time, lane departure, inter-vehicle distance, ignoring traffic lights, night driving, driving in bad weather, driving in traffic jams, driving without lights, drowsy driving, suspected drunk driving, driving while operating a smartphone, sudden stop of the vehicle, sudden start, sudden turn, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall conditions, fog, strong wind, road construction information, accident-prone point information, road congestion degree, traffic regulation information, behavior of surrounding vehicles, pedestrian darting out, and animal darting out are acquired in real time from a wide variety of sensors mounted on a vehicle, such as an acceleration sensor, a gyro sensor, a GPS module, a CAN data acquisition device, an in-vehicle camera, a microphone, a temperature sensor, a humidity sensor, a tire pressure sensor, an illuminance sensor, an inside/outside air pressure sensor, and a driver's biometric sensor.

Step 2: Data Preprocessing and Transmission Preprocessing such as noise removal, data normalization, abnormal value detection, time-series shaping, data compression, encryption, and data anonymization is performed on the acquired data, and after executing drift correction of GPS data, spike removal of acceleration data, abnormal value filtering of CAN data, privacy masking of camera images, noise canceling of audio data, and the like, the data is transmitted to the server every 1 second, every 5 seconds, every 1 minute, or at every event trigger such as when sudden braking occurs or when an accident occurs.

Step 3: Multilateral Data Analysis by Generative AI The generative AI on the server multilaterally and integrally analyzes the driving behavior data, the vehicle state data, and the road environment data using a time-series data generation model, an image generation model, an audio generation model, a multimodal AI model, and the like. For example, the time-series data generation model analyzes a continuous change pattern of driving behavior and predicts future risk behavior from past driving history. The image generation model automatically determines weather and road surface conditions from in-vehicle camera images and extracts a dangerous driving environment. The audio generation model analyzes audio data acquired from an in-vehicle microphone and estimates states such as driver's fatigue, drowsiness, distraction, anger, and stress. The multimodal AI model integrally analyzes these different types of data and generates a comprehensive risk profile of the driver. Specific examples of a prompt sentence to be read into the generative AI include “Extract risk factors such as sudden acceleration, sudden deceleration, sudden steering, speeding, long-time driving, lane departure, ignoring traffic lights, night driving, driving in bad weather, driving in traffic jams, driving without lights, drowsy driving, suspected drunk driving, driving while operating a smartphone, sudden stop of the vehicle, sudden start, sudden turn, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall conditions, fog, strong wind, road construction information, accident-prone point information, road congestion degree, traffic regulation information, behavior of surrounding vehicles, pedestrian darting out, and animal darting out from the following time-series driving data, and calculate a risk score for each driver” and “Estimate weather, road surface conditions, and states such as driver's fatigue, drowsiness, distraction, anger, and stress from in-vehicle camera images and audio data, perform a comprehensive risk evaluation, and reflect it in insurance premium calculation”.

Step 4: Risk Evaluation and Accumulation in Long-Term Memory Based on the output of the generative AI analysis unit, the risk evaluation unit integrally evaluates a plurality of risk factors, for example, when sudden acceleration or sudden deceleration occurs frequently, when driving at night or in bad weather is frequent, when poor maintenance of the vehicle is detected, when dangerous behavior is frequent in traffic jams or accident-prone points, when the driver is driving while operating a smartphone, when drowsy driving or drunk driving is suspected, and when a safety device of the vehicle operates frequently, and dynamically generates a risk score for each driver. In addition, past accident data and driving history data are accumulated in a long-term memory unit and utilized for continuous learning and optimization of the generative AI.

Step 5: Insurance premium calculation and incentive provision. Based on the risk score of the evaluation unit, the insurance premium calculation unit automatically adjusts the insurance premium according to the risk profile for each driver, such as applying a 20 percent discount from a basic insurance premium when the risk score is less than a certain value, and applying a surcharge when the risk score is high. The incentive providing unit automatically provides a discount incentive when safe driving continues for a certain period of time, immediately applies a surcharge when an accident or a violation occurs, and dynamically adjusts the incentive according to a change in the driver's behavior.

Step 6: Automatic settlement process by smart contract. A smart contract processing unit automates a settlement process of an insurance contract and an incentive providing process, automatically starts an insurance payout process when an accident occurs, and immediately recalculates the insurance premium when the driver shows a new risk behavior.

Step 7: Feedback provision by user interface. A user interface unit displays a current risk score, a fluctuation status of the insurance premium, an acquisition status of a safe driving incentive, a past driving history, safe driving advice by AI, and the like on a smartphone application or an in-vehicle display, displays a warning message such as “The risk score is increasing due to frequent sudden braking” when sudden braking occurs frequently, performs an incentive notification such as “The insurance premium is discounted because safe driving is continued” when safe driving continues for a certain period of time, and immediately displays a warning such as “Operating a smartphone while driving is dangerous” when detecting that the driver is driving while operating a smartphone. Specifically, the user interface unit continuously receives a data stream in a JSON format from the server using an asynchronous communication protocol. The data stream includes numerical data of the risk score, a fluctuation amount of the insurance premium, and character string data of a text message. The user interface unit parses the received data stream on a memory. The user interface unit stores the parsed data in an internal state management module. The user interface unit updates a drawing component of a screen using a virtual DOM technology. By this process, redrawing of the entire screen is avoided, and only the changed component is partially re-rendered. The present system reduces a drawing delay to a unit of several milliseconds. The present system minimizes a display delay of the warning message to the driver. The user interface unit executes a rendering algorithm that dynamically changes a text color and a background color according to an importance level of the warning message. The user interface unit activates a speech synthesis engine, converts the text message into an audio signal, and outputs the audio signal from a car speaker. The present technical effect is to provide highly immediate feedback without diverting the driver's line of sight, and to improve an accident avoidance rate. The present configuration is particularly effective in a driving assistance application that requires extremely high real-time performance.

Step 8: Centralized management by corporate management dashboard. A corporate management dashboard unit provides a dashboard capable of centrally managing the risk score and the insurance premium for each vehicle for a corporate vehicle manager who owns a plurality of vehicles, visualizes a driving tendency and a risk factor for each vehicle, grasps a risk behavior of a specific driver to utilize it for education and guidance, and optimizes the overall insurance premium. Specifically, the corporate management dashboard unit acquires aggregated data of vehicles on a scale of tens of thousands from a distributed relational database. The dashboard unit executes a multidimensional online analytical processing engine. The dashboard unit constructs a three-dimensional data cube of a vehicle ID, a time axis, and a risk factor on a memory. The dashboard unit dynamically re-aggregates the data cube by a slice operation and a dice operation in response to an operation input from a user. The dashboard unit renders an aggregation result as a heat map, a scatter plot, and a time-series line graph. The dashboard unit executes a clustering algorithm. An input to the algorithm is a two-dimensional vector including the risk score and the number of violations of each driver. The algorithm classifies drivers into a plurality of risk groups using a K-means method. An output of the algorithm is an identification label of a cluster to which each driver belongs. The dashboard unit highlights a list of drivers classified into a high-risk cluster. By this process, the manager instantly identifies a driver requiring attention from an enormous amount of data. The present technical effect is optimization of calculation resources and speeding up of data visualization in large-scale data processing. The present configuration is extremely useful in a large-scale fleet management system such as a logistics company or a taxi company.

Step 9: Data standardization and heterogeneous data integration. A data standardization unit performs a standardization process on Telematics data compliant with an ISO standard, and even if the data is from different vehicle models or different sensor manufacturers, the generative AI automatically performs standardization and normalization of the data to maintain the accuracy of the risk evaluation model. Specifically, the data standardization unit maps the input data of heterogeneous formats to a common internal schema. The data standardization unit calculates a semantic similarity of column names using a natural language processing model. An input to the model is a character string of metadata transmitted from each sensor. The model converts the character string into a word embedding vector. An output of the model is an adaptation probability distribution for each item of the common schema. The data standardization unit automatically allocates the data to an item having a maximum probability. The data standardization unit executes a unit conversion algorithm. For example, speed data input in miles per hour is converted into kilometers per hour. The data standardization unit applies a spline interpolation algorithm to time-series data having different sampling rates. By this process, all sensor data are projected onto a vector space having the same time resolution. The data standardization unit performs a complement process on a missing value using a moving average value of peripheral data. The present technical effect is to completely prevent deterioration of inference accuracy in the generative AI in a subsequent stage. The present configuration eliminates a bottleneck of data integration in a mobility service platform in which vehicles of a plurality of automobile manufacturers are mixed.

### (Specific Use Case)

For example, when an individual automobile owner uses the system of the present invention, driving behavior data, vehicle state data, and road environment data such as sudden acceleration, sudden deceleration, sudden steering, speeding, long-time driving, idling time, lane departure, inter-vehicle distance, ignoring traffic lights, night driving, driving in bad weather, driving in traffic jams, driving without lights, drowsy driving, suspected drunk driving, driving while operating a smartphone, sudden stop of the vehicle, sudden start, sudden turning, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall situation, fog, strong wind, road construction information, accident-prone point information, road congestion degree, traffic regulation information, behavior of surrounding vehicles, pedestrian darting out, and animal darting out are acquired in real time from an acceleration sensor, a gyro sensor, a GPS module, an in-vehicle camera, a microphone, a temperature sensor, a humidity sensor, a tire pressure sensor, a CAN data acquisition device from a vehicle control system, and the like mounted on the vehicle. These data are transmitted to the server after being subjected to preprocessing such as noise removal, data normalization, abnormal value detection, time-series shaping, data compression, encryption, and data anonymization on the terminal side. On the server side, the generative AI multilaterally and comprehensively analyzes the driving behavior data, the vehicle state data, and the road environment data using a time-series data generation model, an image generation model, an audio generation model, a multimodal AI model, and the like, and comprehensively evaluates a plurality of risk factors, for example, when sudden acceleration or sudden deceleration occurs frequently, when driving at night or in bad weather is frequent, when poor maintenance of the vehicle is detected, when dangerous behavior is frequent in traffic jams or accident-prone points, when the driver is driving while operating a smartphone, when drowsy driving or drunk driving is suspected, or when a safety device of the vehicle is frequently activated, and dynamically generates a risk score for each driver. The generative AI also accumulates past accident data and driving history data in a long-term memory, immediately issues a warning when a similar risk pattern appears, and automatically corrects the risk evaluation model. Based on the risk score of the evaluation unit, the insurance premium calculation unit automatically adjusts the insurance premium according to the risk profile for each driver, such as applying a 20 percent discount from a basic insurance premium when the risk score is less than a certain value, and applying a surcharge when the risk score is high. The incentive providing unit automatically provides a discount incentive when safe driving continues for a certain period of time, immediately applies a surcharge when an accident or a violation occurs, and dynamically adjusts the incentive according to a change in the driver's behavior. The smart contract processing unit automates a settlement process of an insurance contract and an incentive providing process, automatically starts an insurance payout process when an accident occurs, and immediately recalculates the insurance premium when the driver shows a new risk behavior. The user interface unit displays a current risk score, a fluctuation status of the insurance premium, an acquisition status of a safe driving incentive, a past driving history, safe driving advice by AI, and the like on a smartphone application or an in-vehicle display, displays a warning message such as “The risk score is increasing due to frequent sudden braking” when sudden braking occurs frequently, performs an incentive notification such as “The insurance premium is discounted because safe driving is continued” when safe driving continues for a certain period of time, and immediately displays a warning such as “Operating a smartphone while driving is dangerous” when detecting that the driver is driving while operating a smartphone. When a corporate vehicle manager uses the system of the present invention, data collected from a plurality of vehicles are integrated, a dashboard capable of centrally managing the risk score and the insurance premium for each vehicle is provided, a driving tendency and a risk factor for each vehicle are visualized, a risk behavior of a specific driver is grasped and utilized for education and guidance, and the overall insurance premium is optimized. The data standardization unit performs a standardization process on Telematics data compliant with an ISO standard, and even if the data is from different vehicle models or different sensor manufacturers, the generative AI automatically performs standardization and normalization of the data to maintain the accuracy of the risk evaluation model. Specifically, the present system executes a multimodal neural network. An input to the network is a one-dimensional tensor of time-series sensor data, a three-dimensional tensor of a camera image, and a frequency spectrogram of audio data. The network converts each modality into a feature vector by an independent encoder layer. The network combines the feature vectors of different modalities using a cross-attention mechanism. An output of the network is a risk score taking a continuous value from 0 to 100. The present system inputs the output risk score to a threshold determination module. The module triggers a smart contract execution module when the score exceeds a predetermined threshold. The smart contract execution module accesses a distributed ledger on a blockchain and automatically generates a recalculation transaction of the insurance premium. By this process, updating of the insurance premium is completed without human intervention. The present system continuously updates weights of the network using an error backpropagation method. A loss function of the present system is designed to minimize a cross-entropy error between a predicted risk score and actual presence or absence of an accident occurrence. The present technical effect is complete automation of an insurance premium calculation process and a dramatic reduction in processing time. The present configuration enables provision of a personalized insurance product perfectly adapted to individual driving characteristics.

Specific examples of a prompt sentence to be read by the generative AI include “Extract risk factors such as sudden acceleration, sudden deceleration, sudden steering, speeding, long-time driving, lane departure, ignoring traffic lights, night driving, driving in bad weather, driving in traffic jams, driving without lights, drowsy driving, suspected drunk driving, driving while operating a smartphone, sudden stop of the vehicle, sudden start, sudden turning, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall situation, fog, strong wind, road construction information, accident-prone point information, road congestion degree, traffic regulation information, behavior of surrounding vehicles, pedestrian darting out, and animal darting out from the following time-series driving data, and calculate a risk score for each driver”, or “Estimate a state such as weather, a road surface condition, and driver's fatigue, drowsiness, distraction, anger, and stress from an in-vehicle camera image and audio data, perform a comprehensive risk evaluation, and reflect it in an insurance premium calculation”, or “Utilize past accident data and driving history data as a long-term memory, immediately issue a warning when a similar pattern appears, and automatically correct a risk evaluation model”. Furthermore, for a corporate vehicle manager, a prompt such as “Integrate driving data of a plurality of vehicles and generate a dashboard capable of centrally managing a risk score and an insurance premium for each vehicle” is also used. Specifically, the present system controls a large language model by a prompt engineering technology. The present system executes a serializer that converts time-series sensor data, which is numerical data, into a text token sequence. The present system dynamically embeds the converted token sequence into a placeholder of a predefined prompt template. An input to the model is a token embedding vector of several thousand dimensions. The model calculates a long-distance dependency relationship between tokens using a multi-layer self-attention mechanism. An output of the model is structured text data in a JSON format including a classification label of a risk factor and a numerical value of a risk score. The present system parses the output JSON text with a regular expression parser. The present system stores an analysis result in a corresponding column of a relational database. The present system passes the extracted risk score as an input parameter of a subsequent insurance premium calculation algorithm. By this process, a structured risk index is automatically extracted from unstructured data. The present technical effect is realization of context understanding of a complex driving situation and highly accurate risk evaluation. The present configuration exhibits extremely high accuracy in determining an ambiguous driving situation that is difficult to describe by a rule-based program.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. A risk evaluation and insurance premium dynamic calculation system for autonomous vehicles of the present invention is composed of a vehicle-side terminal and a cloud server, and each part functions in a multi-layered and cooperative manner. The vehicle-side terminal is equipped with an acceleration sensor, a gyro sensor, a GPS module, a LIDAR sensor, a camera, a CAN data acquisition device from a vehicle control system, a microphone, a temperature sensor, a humidity sensor, a tire pressure sensor, an illuminance sensor, an inside/outside air pressure sensor, a vehicle battery state sensor, a brake pad wear sensor, an engine diagnosis sensor, a vehicle external obstacle detection sensor, an in-vehicle biometric sensor, and the like. From these sensors, an extremely wide variety of driving behavior data, vehicle state data, road environment data, surrounding traffic situation data, and AI control algorithm behavior data such as speed, acceleration, deceleration, steering angle, LIDAR abnormality, camera abnormality, human intervention from AI control (AI override), sudden stop of the vehicle, sudden start, sudden turning, tire pressure drop, brake pad wear, engine abnormality, battery abnormality, low oil level, vehicle failure diagnosis information, abnormal inside temperature, abnormal outside temperature, road surface temperature, road surface freezing, rainfall/snowfall situation, fog, strong wind, road construction information, accident-prone point information, road congestion degree, traffic regulation information, behavior of surrounding vehicles, pedestrian darting out, animal darting out, signal recognition failure, sign recognition failure, abnormal judgment of an AI algorithm, sensor fusion abnormality, version information of an AI learning model, and automatic update history of AI control are acquired in real time. Specifically, the present system includes an edge gateway directly connected to a controller area network which is an internal network of the autonomous vehicle. The edge gateway acquires data from each sensor at a sampling rate in units of milliseconds. The edge gateway temporarily stores the acquired data in a ring buffer memory. The present system executes a sensor fusion algorithm on an edge processor. The present system performs a calibration matrix operation for spatially aligning three-dimensional point cloud data of LIDAR and two-dimensional pixel data of a camera. By this process, blind spots and weak points of each sensor are mutually complemented, and a single integrated environment model is constructed. The present system extracts bounding box coordinates and a relative velocity vector of an object from the integrated environment model. The present technical effect is an improvement in robustness of environment recognition and a dramatic reduction in false detection. The present configuration becomes an essential basic technology for ensuring safety in a vehicle of fully autonomous driving level 4 or higher.

For example, when a LIDAR sensor temporarily misrecognizes an obstacle and the AI executes an emergency stop, when a camera loses visibility under bad conditions such as backlight, nighttime, dense fog, and heavy rain and the AI makes an error in course judgment, when an AI override in which AI control entrusts control to a human driver occurs a plurality of times, when the vehicle repeats sudden acceleration, sudden deceleration, and sudden steering, when the AI does not issue an appropriate warning even though the tire pressure continues to drop, when an abnormality of an engine or a battery is detected, when the vehicle frequently travels in an accident-prone point, a construction section, or a traffic jam section, when the AI cannot take an appropriate avoidance action against a sudden cut-in of a surrounding vehicle or a pedestrian darting out, when signal or sign recognition failures continue, or when abnormal behavior increases after a version upgrade of an AI algorithm, various risk events and abnormal behaviors that can occur in actual autonomous vehicle operation can be comprehensively converted into data. Specifically, the present system executes an isolation forest as an abnormality detection algorithm. An input to the algorithm is a multidimensional feature vector indicating a dynamic behavior of the vehicle and a status code of a sensor. The algorithm isolates a data point deviating from a normal behavior pattern using a branch of a decision tree. An output of the algorithm is an abnormality score of each data point. The present system flags an event in which the abnormality score exceeds a predetermined threshold as a risk event. The present system cuts out time-series data before and after the flagged event, and saves it in a database as an event log. By this process, even an unknown abnormality pattern is detected and recorded with high accuracy. The present technical effect is comprehensive capture of a complex abnormal behavior that cannot be handled by a rule-based program. The present configuration forms a feedback loop for debugging an autonomous driving algorithm and continuously improving safety.

On the vehicle-side terminal, these data are temporarily accumulated, and after performing preprocessing such as noise removal (e.g., removal of temporary sensor malfunctions and external noise), data normalization (e.g., output value scaling between different sensors), abnormal value detection (e.g., exclusion of physically impossible values), time-series shaping (e.g., unification of event occurrence times), data compression (e.g., compression of image data and time-series data), encryption (e.g., data protection by TLS communication), and data anonymization (e.g., masking of personal information and vehicle identification information), the data are transmitted to a cloud server at a constant cycle (e.g., every 1 second, every 5 seconds, every 1 minute) or at every event trigger (e.g., when an AI override occurs, when a LIDAR abnormality occurs, when an accident occurs, etc.). For example, drift correction of GPS data, spike removal of acceleration data, abnormal value filtering of CAN data, privacy masking of camera images (automatic blurring of pedestrians and license plates), noise canceling of audio data, and the like are executed. Specifically, the vehicle-side terminal includes a hardware accelerator dedicated to digital signal processing. The accelerator applies a finite impulse response low-pass filter to the acceleration data. By this processing, high-frequency noise components caused by minute unevenness of the road surface are removed. The accelerator applies an extended Kalman filter to the GPS data. By this processing, a positioning error due to multipath is statistically corrected, and a true trajectory is estimated. The accelerator executes semantic segmentation using a lightweight convolutional neural network on the image data. The accelerator specifies a pixel region corresponding to a person or a license plate of a vehicle, and applies a Gaussian blurring process. The accelerator encrypts the preprocessed data using an advanced encryption standard algorithm. The vehicle-side terminal publishes the encrypted data to the cloud server using a message queuing telemetry transport protocol. This technical effect is saving of a communication band, reduction of a calculation load on the cloud side, and reliable securing of data security.

On the cloud server side, an enormous amount of data transmitted from the terminal is received, and a multi-stage analysis process by a generative AI is performed. The generative AI is configured by combining a time-series data generation model (e.g., pattern analysis of continuous behavior of AI control and driving behavior), an image generation model (e.g., weather/road surface condition/sign recognition/obstacle detection from camera images), an abnormality detection model (e.g., abnormal signals of LIDAR and cameras, AI override occurrence frequency, inconsistency between sensors, abnormal judgment patterns of AI control), a reinforcement learning model (e.g., self-optimization of an AI control algorithm), a self-supervised learning model (e.g., automatic discovery of unknown risk patterns), a transfer learning model (e.g., adaptation to a new road environment and vehicle model), a multimodal AI model (e.g., integrated analysis of heterogeneous data), and the like. Specifically, the cloud server includes a parallel computing cluster using GPUs. The cluster containerizes a plurality of deep learning models and executes them in parallel. The time-series data generation model adopts a transformer architecture. The image generation model adopts a conditional generative adversarial network. The abnormality detection model adopts a variational autoencoder architecture. The system inputs an output of each model to an ensemble learning module. The module calculates a dynamic weighted average for a prediction result of each model. By this processing, overlearning and prediction errors of a single model are mutually offset. The system pre-learns a useful feature representation from unlabeled data using the self-supervised learning model. This technical effect is a dramatic improvement in accuracy of comprehensive risk evaluation and acquisition of generalization performance for an unknown environment. This configuration makes it possible to always maintain the latest risk evaluation criteria in a daily changing traffic environment.

For example, the time-series data generation model analyzes a continuous change pattern of AI control behavior and driving behavior, and predicts future risk behavior and an abnormality occurrence probability from a past operation history. For example, the image generation model automatically determines weather (clear weather, rain, snow, fog, nighttime, etc.), a road surface condition (dry, wet, frozen, falling object, etc.), recognition accuracy of signs and traffic lights, and the presence or absence of an obstacle from an in-vehicle camera image, and extracts a dangerous driving environment and an AI judgment mistake. For example, the abnormality detection model detects an abnormal signal of LIDAR or a camera, an AI override occurrence frequency, an inconsistency between sensors, an abnormal judgment pattern of AI control, a behavior change after a version upgrade of an AI algorithm, and the like. For example, the multimodal AI model integrally analyzes these different types of data and generates a comprehensive risk profile of the autonomous driving AI. Specifically, an input to the time-series data generation model is a time-series array of a steering angle, an acceleration, and a brake pressure for the past 60 seconds. The number of dimensions of the array is a tensor of 600 rows and 3 columns. An output of the model is a predicted value from 0 to 1 indicating a sudden steering occurrence probability for the next 5 seconds. An input to the image generation model is an RGB image tensor with a resolution of 1920 by 1080 pixels. An output of the model is a continuous value indicating a road surface freezing probability and bounding box coordinates of an obstacle. An input to the abnormality detection model is a combined vector of a reflection intensity histogram of LIDAR and a luminance histogram of a camera. An output of the model is a binary flag indicating an inconsistency between sensors. The system inputs these outputs to a fully connected layer of the multimodal AI model. The multimodal AI model non-linearly transforms each input feature amount and outputs a final risk profile vector. The system transfers the output vector to a subsequent insurance premium calculation module. This technical effect is realization of quantitative and integrated evaluation of multilateral environmental factors and vehicle states.

The generative AI multilaterally analyzes a plurality of risk factors such as speeding, sudden acceleration/deceleration, sudden steering, LIDAR abnormality, camera abnormality, human intervention from AI control, bad weather, bad road surface, high traffic density, traffic light recognition failure, sign recognition failure, abnormal judgment of an AI algorithm, sensor fusion abnormality, version information of an AI learning model, and an automatic update history of AI control, and calculates a risk score for each vehicle. For example, various risk factors are integrally evaluated, such as a vehicle in which AI overrides frequently occur, a vehicle in which LIDAR or camera abnormalities frequently occur, a vehicle with many AI judgment mistakes in bad weather or a congested environment, a vehicle with much sudden acceleration/deceleration or sudden steering, a vehicle with much risk behavior in a situation with high traffic density, a vehicle in which recognition failures of traffic lights and signs continue, and a vehicle in which abnormal behavior has increased after a version upgrade of an AI algorithm, and a risk score is dynamically generated. The generative AI also accumulates past accident data and operation history data in a long-term memory unit, immediately issues a warning when a similar risk pattern appears, and automatically corrects a risk evaluation model. For example, an operation pattern in which an accident occurred in the past and characteristics of an AI judgment mistake are learned, and when a similar situation is reproduced, the risk score is set high. For example, when risk behavior decreases after an algorithm update of AI control, the risk score is automatically reduced. Specifically, the generative AI calculates a final risk score using a multilayer perceptron. An input to the perceptron is a multidimensional feature amount vector obtained by one-hot encoding a probability value, a binary flag, and a categorical variable output from each model. The perceptron applies a ReLU function, which is a non-linear activation function, in a hidden layer. An output layer of the perceptron outputs a risk score normalized to a range of 0 to 100 using a sigmoid function. The system stores the calculated risk score in a time-series database. The system calculates an exponential moving average of a past score history and a current score. By this processing, a rapid fluctuation of the score due to temporary noise is smoothed. The system executes an online learning algorithm and fine-tunes a weight of the perceptron every time new accident data is input. This technical effect is provision of a stable foundation for insurance premium calculation and improvement of adaptability of the model to an environmental change.

The insurance premium calculation unit automatically adjusts an autonomous driving AI insurance premium or a safety score according to a risk profile for each vehicle based on the risk score of the risk evaluation unit, for example, by applying a 30 percent discount from a basic insurance premium when the risk score is less than a certain value, and applying a surcharge when the risk score is high. For example, an insurance premium is discounted for a vehicle in which stable autonomous driving is continued, and a surcharge is applied to a vehicle with many abnormalities and interventions. An incentive providing unit automatically provides a discount incentive when safe driving and high-quality AI control continue for a certain period of time, immediately applies a surcharge when an abnormality or an accident occurs, and promotes improvement of an AI algorithm and optimization of a maintenance plan. A smart contract processing unit automates a settlement process of an insurance contract and an incentive providing process, automatically starts an insurance payout process when an accident occurs, and immediately recalculates an insurance premium when an abnormality of AI control is detected. Specifically, the insurance premium calculation unit determines a discount rate and a surcharge rate of an insurance premium using a gradient boosting decision tree algorithm. The smart contract processing unit accesses a distributed ledger on a blockchain network such as Ethereum. The processing unit hashes the calculated insurance premium data and risk score using a SHA256 algorithm. The processing unit writes the generated hash value to the blockchain as a transaction. The processing unit executes a predefined condition determination script on a virtual machine that is an execution environment of a smart contract. The processing unit automatically generates a remittance transaction of a digital token corresponding to an insurance payout when an accident occurrence flag becomes true. By this processing, execution of a contract is immediately guaranteed without going through an approval process of a third-party organization. This technical effect is securing of transparency of transaction processing, prevention of falsification, and dramatic reduction of an administrative processing cost. This configuration provides an indispensable technical foundation in operation of microinsurance and pay-as-you-go insurance.

A user interface unit displays a current risk score, a fluctuation status of an insurance premium, an acquisition status of a safe driving incentive, a past operation history, safe driving advice by AI, and the like on a dashboard or a management screen for an operation manager and an AI developer. For example, when LIDAR abnormalities frequently occur, a warning message such as “The risk score is increasing because there are many LIDAR abnormalities” is displayed, and when AI overrides frequently occur, a notification such as “An insurance premium will be surcharged because human intervention from AI control frequently occurs” is performed. For a corporate manager, a dashboard capable of collectively managing risk scores and insurance premiums of a plurality of vehicles is provided, a driving tendency and a risk factor for each vehicle are visualized, a risk trend for each specific vehicle and AI version is grasped, and it can be utilized for an update of an AI algorithm and a maintenance plan. For example, it is also possible to compare a risk tendency for each version of an AI algorithm and determine an optimal algorithm selection and update timing. Specifically, the user interface unit establishes a bidirectional persistent connection with a server using a WebSocket communication protocol. The interface unit receives an update event of a risk score and an abnormality detection alert push-distributed from the server in real time. The interface unit redraws an SVG-based graph drawing component on the dashboard based on the received event data. The interface unit generates a pop-up alert by a modal window on a screen when an abnormality occurs. The interface unit calculates a variance of a risk score for each AI version and renders it as a box plot. By this processing, the operation manager grasps the latest vehicle state and statistical information of the entire fleet without reloading a browser. This technical effect is minimization of cognitive delay in monitoring work and speeding up of data-driven decision making. This configuration functions as a powerful management tool for maximizing operational efficiency of an autonomous driving fleet.

A data standardization unit standardizes Telematics data compliant with an ISO standard and heterogeneous data from a plurality of sensor platforms, and even if the data is from different vehicle models or different sensor manufacturers, the generative AI automatically standardizes and normalizes the data, thereby maintaining accuracy of a risk evaluation model. For example, output data of different LIDAR manufacturers and camera manufacturers are integrated, a version difference of an AI control algorithm is absorbed, and cross-vehicle risk evaluation is realized. For example, a corporation owning a plurality of autonomous vehicles can collectively manage risk scores and insurance premiums of all vehicles, compare and analyze an operation tendency and performance of an AI algorithm for each vehicle, and utilize them for optimization of operation management and AI development. Specifically, the data standardization unit includes an API gateway implemented as a microservice architecture. The standardization unit analyzes a protocol header of input data. The standardization unit determines a data format of a payload. The standardization unit dynamically loads an appropriate decoder module based on a determination result. The standardization unit serializes the decoded data into a protocol buffer format which is an internal common format. The standardization unit applies a rotation and translation transformation matrix of a coordinate system to point cloud data of different LIDAR manufacturers, and maps it to a common vehicle-centric coordinate system. By this processing, even when a new sensor device or a different version of AI software is added, modification of the entire system becomes unnecessary. This technical effect is a dramatic improvement in scalability and maintainability of the system. This configuration completely guarantees interoperability of an autonomous driving platform in a multi-vendor environment.

As described above, in the embodiment of the present invention, by adopting a configuration in which collection and preprocessing of sensor data are performed by a vehicle-side terminal, and multilateral data analysis, risk evaluation, insurance premium calculation, smart contract processing, data standardization, provision of a dashboard for corporations, and the like by a generative AI are realized on a cloud server side, AI control quality and safety of an autonomous vehicle can be objectively evaluated in real time, and can be reflected in an insurance premium, operation management, an improvement guideline for an AI algorithm, a maintenance plan, and the like. For example, a vehicle in which LIDAR or camera abnormalities frequently occur or a vehicle in which AI overrides frequently occur has a high risk score and an insurance premium is surcharged, so that an operation manager can promote early maintenance and improvement of an AI algorithm. Conversely, an insurance premium is discounted for a vehicle in which stable autonomous driving is continued, which leads to a reduction in an operation cost and an improvement in reliability of AI technology. Furthermore, all risk factors in actual autonomous vehicle operation, such as version management and an update history of an AI algorithm, accuracy of sensor fusion, frequency of abnormality detection, and diversity of an operation environment, are comprehensively covered, and both safety guarantee and economic rationality in social implementation are realized. Specifically, the system adopts a distributed processing architecture that cooperatively operates edge computing and cloud computing. The system completes high-load signal processing and data compression on an edge side. The system significantly reduces an amount of data transmitted to a cloud side. The system aggregates computing resources on the cloud side and drives a large-scale deep learning model. By this processing, advanced inference is realized while preventing depletion of a network band. The system monitors a communication delay between the edge and the cloud, and executes a fallback mechanism that dynamically increases a specific weight of inference processing on the edge side when the delay is large. This technical effect is minimization of end-to-end latency of the entire system, maximization of throughput, and improvement of fault tolerance against a communication failure. This configuration strongly supports stable operation of a mission-critical autonomous driving insurance system.

### (System Configuration)

The system according to the present embodiment includes a data acquisition unit, a data preprocessing unit, a data transmission unit, a generative AI analysis unit, a risk evaluation unit, an insurance premium calculation unit, an incentive providing unit, a smart contract processing unit, a user interface unit, a data long-term memory unit, a corporate management dashboard unit, and a data standardization unit. The data acquisition unit acquires driving behavior data, vehicle state data, road environment data, surrounding traffic situation data, and AI control algorithm behavior data in real time, such as speed, acceleration, deceleration, steering angle, LIDAR abnormality, camera abnormality, human intervention from AI control, sudden stop of a vehicle, sudden start, sudden turning, tire pressure drop, brake pad wear, engine abnormality, battery abnormality, oil level drop, vehicle failure diagnosis information, inside temperature abnormality, outside temperature abnormality, road surface temperature, road surface freezing, rainfall/snowfall situation, fog, strong wind, road construction information, accident-prone point information, road congestion degree, traffic regulation information, behavior of surrounding vehicles, pedestrian darting out, animal darting out, traffic light recognition failure, sign recognition failure, abnormal judgment of an AI algorithm, sensor fusion abnormality, version information of an AI learning model, and an automatic update history of AI control, from a wide variety of sensors mounted on a vehicle, such as an acceleration sensor, a gyro sensor, a GPS module, a LIDAR sensor, a camera, a CAN data acquisition device from a vehicle control system, a microphone, a temperature sensor, a humidity sensor, a tire pressure sensor, an illuminance sensor, an inside/outside air pressure sensor, a vehicle battery state sensor, a brake pad wear sensor, an engine diagnosis sensor, a vehicle external obstacle detection sensor, and an in-vehicle biometric sensor. The data preprocessing unit performs noise removal, data normalization, abnormal value detection, time-series shaping, data compression, encryption, data anonymization, and the like on the acquired data, and executes, for example, drift correction of GPS data, spike removal of acceleration data, abnormal value filtering of CAN data, privacy masking of camera images, noise canceling of audio data, and the like. The data transmission unit transmits the preprocessed data to a server, for example, every 1 second, every 5 seconds, every 1 minute, or at every event trigger such as when an AI override occurs, when a LIDAR abnormality occurs, or when an accident occurs. The generative AI analysis unit operates on the server, and multilaterally and integrally analyzes the driving behavior data, the vehicle state data, the road environment data, the surrounding traffic situation data, and the AI control algorithm behavior data by combining a time-series data generation model, an image generation model, an abnormality detection model, a reinforcement learning model, a self-supervised learning model, a transfer learning model, a multimodal AI model, and the like. For example, the time-series data generation model analyzes a continuous change pattern of AI control behavior and driving behavior, and predicts future risk behavior and an abnormality occurrence probability from a past operation history. For example, the image generation model automatically determines weather, a road surface condition, sign recognition, and obstacle detection from an in-vehicle camera image, and extracts a dangerous driving environment and an AI judgment mistake. For example, the abnormality detection model detects an abnormal signal of LIDAR or a camera, an AI override occurrence frequency, an inconsistency between sensors, an abnormal judgment pattern of AI control, a behavior change after a version upgrade of an AI algorithm, and the like. For example, the multimodal AI model integrally analyzes these different types of data and generates a comprehensive risk profile of the autonomous driving AI. The risk evaluation unit multilaterally analyzes a plurality of risk factors such as speeding, sudden acceleration/deceleration, sudden steering, LIDAR abnormality, camera abnormality, human intervention from AI control, bad weather, bad road surface, high traffic density, traffic light recognition failure, sign recognition failure, abnormal judgment of an AI algorithm, sensor fusion abnormality, version information of an AI learning model, and an automatic update history of AI control based on an output of the generative AI analysis unit, and calculates a risk score for each vehicle. For example, various risk factors are integrally evaluated, such as a vehicle in which AI overrides frequently occur, a vehicle in which LIDAR or camera abnormalities frequently occur, a vehicle with many AI judgment mistakes in bad weather or a congested environment, a vehicle with much sudden acceleration/deceleration or sudden steering, a vehicle with much risk behavior in a situation with high traffic density, a vehicle in which recognition failures of traffic lights and signs continue, and a vehicle in which abnormal behavior has increased after a version upgrade of an AI algorithm, and a risk score is dynamically generated. The insurance premium calculation unit automatically adjusts an autonomous driving AI insurance premium or a safety score according to a risk profile for each vehicle based on the risk score of the risk evaluation unit, for example, by applying a 30 percent discount from a basic insurance premium when the risk score is less than a certain value, and applying a surcharge when the risk score is high. The incentive providing unit automatically provides a discount incentive when safe driving and high-quality AI control continue for a certain period of time, immediately applies a surcharge when an abnormality or an accident occurs, and promotes improvement of an AI algorithm and optimization of a maintenance plan. The smart contract processing unit automates a settlement process of an insurance contract and an incentive providing process, automatically starts an insurance payout process when an accident occurs, and immediately recalculates an insurance premium when an abnormality of AI control is detected. The user interface unit displays a current risk score, a fluctuation status of an insurance premium, an acquisition status of a safe driving incentive, a past operation history, safe driving advice by AI, and the like on a dashboard or a management screen for an operation manager and an AI developer. For example, when LIDAR abnormalities frequently occur, a warning message such as “The risk score is increasing because there are many LIDAR abnormalities” is displayed, and when AI overrides frequently occur, a notification such as “An insurance premium will be surcharged because human intervention from AI control frequently occurs” is performed. The corporate management dashboard unit provides a dashboard capable of collectively managing risk scores and insurance premiums of a plurality of vehicles, visualizes a driving tendency and a risk factor for each vehicle, grasps a risk trend for each specific vehicle and AI version, and can be utilized for an update of an AI algorithm and a maintenance plan. The data long-term memory unit accumulates past accident data and operation history data over a long period of time, utilizes them for continuous learning and optimization of the generative AI, learns, for example, an operation pattern in which an accident occurred in the past and characteristics of an AI judgment mistake, and sets the risk score high when a similar situation is reproduced. The data standardization unit standardizes Telematics data compliant with an ISO standard and heterogeneous data from a plurality of sensor platforms, and even if the data is from different vehicle models or different sensor manufacturers, the generative AI automatically standardizes and normalizes the data, thereby maintaining accuracy of a risk evaluation model. Specific examples of a prompt sentence to be read by the generative AI include “Calculate a risk score for each vehicle and extract an abnormality and a risk factor from the following time-series driving data, LIDAR abnormality, camera abnormality, AI override, weather, road surface condition, traffic density, traffic light recognition failure, sign recognition failure, version information of an AI algorithm, and the like” and “Estimate abnormal behavior of AI control and an environmental risk from an in-vehicle camera image and sensor data, and reflect them in insurance premium calculation”. Specifically, the system deploys each processing unit as an independent microservice container on a virtualized environment. The system dynamically optimizes allocation of CPU and memory resources of each processing unit using a container orchestration tool. The data acquisition unit delivers data to the data preprocessing unit via a shared memory area. The generative AI analysis unit caches an inference result in an in-memory database. The risk evaluation unit reads the cached inference result at high speed. By this processing, a data transfer overhead between modules is reduced to the utmost limit. The system adopts a gRPC protocol for communication between respective modules, and realizes high-speed inter-process communication in a binary format. This technical effect is improvement of real-time processing performance of the entire system and securing of scalability at the time of high load. This configuration provides a robust back-end foundation for processing simultaneous connection requests from millions of connected cars without delay.

### (Implementation Steps)

Step 1: Multidimensional Collection of Sensor Data Driving behavior data, vehicle state data, road environment data, surrounding traffic situation data, and AI control algorithm behavior data, such as speed, acceleration, deceleration, steering angle, LIDAR abnormality, camera abnormality, human intervention from AI control, sudden stop of the vehicle, sudden start, sudden turning, tire pressure drop, brake pad wear, engine abnormality, battery abnormality, low oil level, vehicle failure diagnosis information, inside temperature abnormality, outside temperature abnormality, road surface temperature, road surface freezing, rainfall/snowfall situation, fog, strong wind, road construction information, accident-prone point information, road congestion degree, traffic regulation information, behavior of surrounding vehicles, pedestrian darting out, animal darting out, signal recognition failure, sign recognition failure, abnormal judgment of AI algorithm, sensor fusion abnormality, version information of AI learning model, and automatic update history of AI control, are acquired in real time from a wide variety of sensors such as an acceleration sensor, a gyro sensor, a GPS module, a LIDAR sensor, a camera, a CAN data acquisition device from a vehicle control system, a microphone, a temperature sensor, a humidity sensor, a tire pressure sensor, an illuminance sensor, an inside/outside air pressure sensor, a vehicle battery state sensor, a brake pad wear sensor, an engine diagnosis sensor, a vehicle external obstacle detection sensor, and an in-vehicle biometric sensor mounted on the vehicle. Specifically, the data acquisition unit reads data in parallel from a plurality of sensor interfaces using multi-thread processing. The acquisition unit executes a time stamp synchronization algorithm in order to absorb a difference in sampling rate of each sensor. The acquisition unit linearly interpolates data of other low-frequency sensors based on an internal clock of a sensor having the highest frequency. By this processing, all sensor data are aligned on the same time axis. The acquisition unit directly writes the acquired data into a main memory by direct memory access transfer. The technical effect is a reduction in an interrupt processing load of a CPU and complete elimination of a calculation error caused by a time lag in subsequent sensor fusion processing. This configuration generates a high-quality data set that is a prerequisite for precise environment recognition of an autonomous vehicle.

Step 2: Data Preprocessing and Transmission Preprocessing such as noise removal, data normalization, abnormal value detection, time-series shaping, data compression, encryption, and data anonymization is performed on the acquired data, and after drift correction of GPS data, spike removal of acceleration data, abnormal value filtering of CAN data, privacy masking of camera images, noise canceling of audio data, and the like are executed, the data is transmitted to a server every 1 second, every 5 seconds, every 1 minute, or at every event trigger such as when an AI override occurs, when a LIDAR abnormality occurs, or when an accident occurs. Specifically, the data preprocessing unit sequentially processes data using a stream processing engine. The preprocessing unit divides time-series data into chunks of a certain size by a sliding window method. The preprocessing unit applies a fast Fourier transform to data in each window, and performs noise filtering in a frequency domain. The preprocessing unit losslessly compresses the data after completion of the processing using a Zlib algorithm. The transmission unit asynchronously transmits data using a message queuing protocol. The transmission unit monitors a connection state of a network, and spools data to a local storage when offline. The transmission unit batch-transmits the spooled data when returning online. By this processing, data loss is completely prevented even when the network is temporarily disconnected. The technical effect is an improvement in reliability of data transmission and efficient use of a communication band. This configuration enables uninterrupted data collection even in a vehicle traveling in a mountainous area or a tunnel where a communication environment is unstable.

Step 3: Multilateral Data Analysis by Generative AI A generative AI on the server multilaterally and integrally analyzes the driving behavior data, the vehicle state data, the road environment data, the surrounding traffic situation data, and the AI control algorithm behavior data using a time-series data generation model, an image generation model, an abnormality detection model, a reinforcement learning model, a self-supervised learning model, a transfer learning model, a multimodal AI model, and the like. For example, the time-series data generation model analyzes a continuous change pattern of AI control behavior and driving behavior, and predicts future risk behavior and an abnormality occurrence probability from past operation history. The image generation model automatically discriminates weather, a road surface situation, sign recognition, and obstacle detection from an in-vehicle camera image, and extracts a dangerous driving environment and an AI judgment error. The abnormality detection model detects an abnormal signal of a LIDAR or a camera, an AI override occurrence frequency, an inconsistency between sensors, an abnormal judgment pattern of AI control, a behavior change after a version upgrade of an AI algorithm, and the like. The multimodal AI model integrally analyzes these different types of data, and generates a comprehensive risk profile of an autonomous driving AI. Specific examples of a prompt sentence to be read by the generative AI include “Calculate a risk score for each vehicle and extract an abnormality and a risk factor from the following time-series driving data, LIDAR abnormality, camera abnormality, AI override, weather, road surface situation, traffic density, signal recognition failure, sign recognition failure, version information of an AI algorithm, and the like” and “Estimate abnormal behavior of AI control and an environmental risk from an in-vehicle camera image and sensor data, and reflect them in insurance premium calculation”. Specifically, the generative AI analysis unit utilizes a tensor processing unit to speed up matrix calculation. The analysis unit batches input multidimensional data, and collectively executes forward propagation calculation of a neural network. An input to the analysis unit is a three-dimensional tensor composed of preprocessed sensor data. Dimensions of the tensor are composed of a batch size, a sequence length, and the number of features. An output of the analysis unit is a probability distribution vector for each risk factor. The analysis unit normalizes the output probability distribution with a softmax function. The system passes the normalized probability distribution to a subsequent risk evaluation module. By this processing, relative importance of a plurality of risk factors is quantified. The technical effect is realization of highly accurate situation recognition in a complex driving environment and an improvement in throughput of inference processing. This configuration maximizes performance of a cloud infrastructure that processes an enormous amount of vehicle data in real time.

Step 4: Risk Evaluation and Accumulation in Long-Term Memory Based on an output of the generative AI analysis unit, the risk evaluation unit multilaterally analyzes a plurality of risk factors such as speeding, sudden acceleration/deceleration, sudden steering, LIDAR abnormality, camera abnormality, human intervention from AI control, bad weather, bad road surface, high traffic density, signal recognition failure, sign recognition failure, abnormal judgment of AI algorithm, sensor fusion abnormality, version information of AI learning model, and automatic update history of AI control, and dynamically generates a risk score for each vehicle. In addition, past accident data and operation history data are accumulated in a long-term memory unit, and utilized for continuous learning and optimization of the generative AI. Specifically, the risk evaluation unit calculates an inner product of a probability distribution vector and a predefined weight matrix, and derives a risk score that is a single scalar value. The long-term memory unit persists data using a distributed key-value store. The memory unit constructs an index using a composite key of a vehicle ID and a time stamp. The memory unit asynchronously reads past data in a background process, and converts a format as a learning data set. The system executes fine tuning of the generative AI using the converted data set. By this processing, a continuous learning loop of a model is run without degrading performance of inference processing. The technical effect is acquisition of self-evolution capability of the system and an improvement in long-term inference accuracy. This configuration enables the system to automatically adapt to a new traffic rule and an unknown environmental change.

Step 5: Insurance Premium Calculation and Incentive Provision Based on the risk score of the risk evaluation unit, the insurance premium calculation unit automatically adjusts an autonomous driving AI insurance premium or a safety score according to a risk profile for each vehicle, such as applying a 30 percent discount from a basic insurance premium when the risk score is less than a certain value, and applying a surcharge when the risk score is high. An incentive provision unit automatically provides a discount incentive when safe driving or high-quality AI control continues for a certain period of time, and immediately applies a surcharge when an abnormality or an accident occurs, thereby promoting improvement of an AI algorithm and optimization of a maintenance plan. Specifically, the insurance premium calculation unit executes a dynamic pricing algorithm. The system acquires the risk score output from the risk evaluation unit. The risk score is a one-dimensional scalar value taking a continuous value from zero to one, for example. The insurance premium calculation unit includes a regression model using a multilayer perceptron. The regression model has an input layer, a plurality of intermediate layers, and an output layer. The regression model receives, as an input, a multidimensional feature vector including a travel distance, an operation time, and a regional coefficient of the vehicle in addition to the risk score. The multidimensional feature vector is configured as a ten-dimensional floating-point array, for example. The regression model executes normalization preprocessing for each input element. The regression model applies a rectified linear unit as an activation function. The regression model calculates an insurance premium adjustment coefficient as an output. The insurance premium adjustment coefficient takes a continuous value from minus 0.3 to plus 0.5, for example. The insurance premium calculation unit multiplies the basic insurance premium by the insurance premium adjustment coefficient. The insurance premium calculation unit determines a final applied insurance premium. The incentive provision unit executes a time-series state determination engine. The time-series state determination engine calculates a moving average of risk scores for a past certain period. The time-series state determination engine determines whether or not a state in which the moving average value falls below a preset threshold value has continued. The incentive provision unit generates a discount flag when a condition is satisfied. The discount flag is a binary value of zero or one. The system transmits the discount flag to subsequent billing database update processing. The system constantly monitors an alert signal from the abnormality detection model. The system immediately generates a surcharge flag when receiving an alert signal indicating occurrence of an accident. The system recalculates the insurance premium in real time based on the surcharge flag without waiting for a next insurance premium calculation cycle. This processing method is different from conventional insurance premium update work by batch processing. This processing method dynamically allocates computing resources of a computer in an event-driven manner. This processing method optimizes an update frequency of a database. This processing method brings about a technical effect of reducing a calculation load of the entire system. This system functions extremely effectively in a specific use case of real-time insurance premium optimization of an autonomous driving fleet.

Step 6: Automatic Settlement Process by Smart Contract A smart contract processing unit automates a settlement process of an insurance contract and an incentive provision process, automatically starts an insurance payout process when an accident occurs, and immediately recalculates an insurance premium when an abnormality of AI control is detected. Specifically, the smart contract processing unit constructs a transaction execution environment based on a distributed ledger technology. The system forms a blockchain network composed of a plurality of nodes. The smart contract processing unit deploys a predefined execution condition to each node as a program code. The smart contract processing unit receives trigger data from an external oracle system. The trigger data includes, for example, an accident occurrence flag, an abnormality detection score, and travel distance data. The trigger data is a fixed-length vector encrypted as a 256-bit hash value, for example. The smart contract processing unit decrypts the received trigger data. The smart contract processing unit determines whether or not the trigger data satisfies the execution condition by a logical operation. The smart contract processing unit automatically generates an insurance payout transaction when the accident occurrence flag is one. The transaction is structured data including a remittance destination address, a remittance amount, and a time stamp. The smart contract processing unit broadcasts the generated transaction to other nodes on the network. The network verifies validity of the transaction using a consensus algorithm. The network records the successfully verified transaction in a new block. The system monitors an abnormality probability score output from the abnormality detection model. The abnormality probability score is a floating-point number from zero to one, for example. The smart contract processing unit calls an insurance premium recalculation function when the abnormality probability score exceeds a threshold value. The insurance premium recalculation function calculates a new insurance premium amount and updates a contract status on a ledger. This processing method completely eliminates an assessment task and an approval process by a human. This processing method executes a deterministic state transition based on a cryptographic proof. This processing method avoids concentration of access to a centralized database server. This processing method brings about a technical effect of dramatically shortening latency of transaction processing. This system realizes high reliability and processing efficiency in a specific use case of an automatic insurance payout system for an autonomous vehicle using a distributed ledger.

Step 7: Feedback Provision by User Interface A user interface unit displays a current risk score, a fluctuation situation of an insurance premium, an acquisition situation of a safe driving incentive, past operation history, safe driving advice by AI, and the like on a dashboard or a management screen for an operation manager or an AI developer, displays a warning message such as “The risk score is increasing because there are many LIDAR abnormalities” when LIDAR abnormalities occur frequently, and issues a notification such as “The insurance premium will be surcharged because human intervention from AI control occurs frequently” when AI overrides occur frequently. Specifically, the user interface unit includes a dynamic rendering engine. A display control unit receives telemetry data streamed in real time from a back-end server. The telemetry data is a multidimensional time-series array including a risk score, an insurance premium amount, and an incentive flag. The display control unit converts the received data into a drawing parameter of a graphical component. The system includes a natural language generation model. The natural language generation model adopts a deep learning architecture equipped with a self-attention mechanism. The natural language generation model receives a risk factor vector as an input. The risk factor vector is a ten-dimensional integer array indicating, for example, the number of occurrences of LIDAR abnormalities, the number of overrides, and the number of sudden brakings. The natural language generation model projects the input vector into a continuous value representation in a latent space. The natural language generation model autoregressively generates a text token sequence along a context using a decoder network. The natural language generation model generates character string data of a warning message as an output. The output data is text data such as “The risk score is increasing because there are many LIDAR abnormalities”, for example. The output data is text data such as “The insurance premium will be surcharged because human intervention occurs frequently”, for example. The display control unit asynchronously draws the generated text data in a specific area on the dashboard. The display control unit dynamically changes a color, a font size, and a blinking cycle of text according to importance of a warning. This processing method is different from a conventional method of enumerating fixed error messages. This processing method converts high-dimensional sensor abnormality data into a natural language representation that can be intuitively understood by a human in real time. This processing method optimizes a rendering load on a client terminal side. This processing method brings about a technical effect of significantly reducing a communication band by limiting an amount of data transmitted via a network to only text tokens. This system functions extremely effectively in a specific use case of a real-time monitoring dashboard for hundreds of vehicles in an operation management center.

Step 8: Collective Management by Corporate Management Dashboard A corporate management dashboard unit provides a dashboard capable of collectively managing risk scores and insurance premiums of a plurality of vehicles, visualizes a driving tendency and a risk factor for each vehicle, grasps a risk trend for each specific vehicle or AI version, and can be utilized for an update of an AI algorithm and a maintenance plan. Specifically, the corporate management dashboard unit executes a large-scale data aggregation pipeline. An aggregation processing unit collectively acquires operation history data of a plurality of vehicles from a database. The system expands the acquired data as a multidimensional tensor on a memory. The multidimensional tensor is configured as a third-order tensor of a vehicle identifier, a time axis, and a risk feature amount, for example. The system applies a dimensionality reduction algorithm. The system converts high-dimensional data into two-dimensional or three-dimensional coordinate data for visualization using, for example, principal component analysis or t-distributed stochastic neighbor embedding. The system executes a clustering model. The clustering model adopts a density-based spatial clustering algorithm, for example. The clustering model receives a risk feature vector of each vehicle as an input. The risk feature vector is a twenty-dimensional numerical array including, for example, an average speed, a sudden acceleration frequency, and the number of system interventions. The clustering model calculates a density of data points in a feature space. The clustering model groups a vehicle group having a similar driving tendency as the same cluster. The clustering model generates a cluster identifier to which each vehicle belongs as an output. The cluster identifier is an integer value from zero to nine, for example. The clustering model outputs barycentric coordinates and a variance value of each cluster. The corporate management dashboard unit color-codes the vehicle group based on the cluster identifier and draws it on a scatter plot. The corporate management dashboard unit statistically tests a correlation between a specific artificial intelligence algorithm version and a cluster. The system automatically highlights a cluster showing an abnormal risk trend. This processing method completely replaces individual data aggregation work by a human. This processing method extracts a correlation of hidden risk factors at high speed by vector calculation in a high-dimensional space. This processing method reduces a calculation amount in visualization of large-scale data. This processing method brings about a technical effect of optimizing memory usage. This system functions as a powerful decision-making support tool in a specific use case of integrated management of an autonomous driving truck fleet of hundreds of vehicles and formulation of a preventive maintenance plan in a logistics company.

Step 9: Data Standardization and Heterogeneous Data Integration A data standardization unit standardizes Telematics data compliant with an ISO standard and heterogeneous data from a plurality of sensor platforms, and even if data is from different vehicle models or different sensor manufacturers, the generative AI automatically standardizes and normalizes the data, thereby maintaining accuracy of the risk evaluation model. Specifically, the data standardization unit executes a multimodal data integration pipeline. The system receives raw data asynchronously transmitted from a plurality of different information sources. The raw data is, for example, text data in a JSON format transmitted from a vehicle of manufacturer A. The raw data is, for example, unique binary format data transmitted from a sensor of manufacturer B. The data standardization unit identifies a format of each data and executes initial parsing processing. The system executes a generative artificial intelligence including a self-supervised learning model. The generative artificial intelligence is configured as an autoencoder based on a transformer architecture, for example. The autoencoder includes an encoder network and a decoder network. The encoder network receives raw data in heterogeneous formats as an input. The encoder network converts the input data into a common latent space vector. The latent space vector is a 512-dimensional floating-point array, for example. The decoder network reconstructs a standardized data structure from the latent space vector. The generative artificial intelligence generates a standardized tensor having a unified schema as an output. The standardized tensor is a fixed-length multidimensional array including, for example, a time stamp, a sensor type, and a normalized measurement value. The generative artificial intelligence simultaneously executes interpolation of a missing value and conversion of a sampling rate. The system transfers the output standardized tensor to an input buffer of a subsequent risk evaluation model. This processing method is fundamentally different from a conventional method depending on a complex conversion rule base manually created by a human. This processing method flexibly adapts to an unknown data format by utilizing representation learning capability of a deep learning model. This processing method speeds up parsing processing at the time of heterogeneous data integration. This processing method brings about a technical effect of maximizing parallelization efficiency of matrix calculation by fixing an input dimension in a subsequent inference model. This system exhibits extremely high scalability in a specific use case of an integrated data analysis infrastructure in a car sharing service in which vehicles of a plurality of manufacturers are mixed.

### (Specific Use Case)

For example, when an autonomous vehicle is operated in a complex traffic environment in an urban area, driving behavior data, vehicle state data, road environment data, surrounding traffic situation data, and AI control algorithm behavior data, such as speed, acceleration, deceleration, steering angle, LIDAR abnormality, camera abnormality, human intervention from AI control, sudden stop of the vehicle, sudden start, sudden turning, tire pressure drop, brake pad wear, engine abnormality, battery abnormality, low oil level, vehicle failure diagnosis information, inside temperature abnormality, outside temperature abnormality, road surface temperature, road surface freezing, rainfall/snowfall situation, fog, strong wind, road construction information, accident-prone point information, road congestion degree, traffic regulation information, behavior of surrounding vehicles, pedestrian darting out, animal darting out, signal recognition failure, sign recognition failure, abnormal judgment of AI algorithm, sensor fusion abnormality, version information of AI learning model, and automatic update history of AI control, are acquired in real time from an acceleration sensor, a gyro sensor, a GPS module, a LIDAR sensor, a camera, a CAN data acquisition device from a vehicle control system, a microphone, a temperature sensor, a humidity sensor, a tire pressure sensor, an illuminance sensor, an inside/outside air pressure sensor, a vehicle battery state sensor, a brake pad wear sensor, an engine diagnosis sensor, a vehicle external obstacle detection sensor, an in-vehicle biometric sensor, and the like mounted on the vehicle. For example, it is possible to comprehensively convert various risk events and abnormal behaviors that can occur in actual autonomous vehicle operation into data, such as when signal recognition failures continue at an intersection in an urban area and the AI repeats emergency stops, when the LIDAR sensor erroneously recognizes an obstacle due to reflection noise and the AI frequently executes a course change or an avoidance operation, when visibility of the camera decreases at night or in dense fog and the AI makes an error in course judgment, when the AI cannot take an appropriate avoidance action against a sudden cut-in of a surrounding vehicle or a pedestrian darting out in a situation where traffic density is high, and when abnormal behavior increases after a version upgrade of the AI algorithm. These data are transmitted to a cloud server after being subjected to preprocessing such as noise removal, data normalization, abnormal value detection, time-series shaping, data compression, encryption, and data anonymization in a vehicle-side terminal. In the cloud server, a generative AI multilaterally and integrally analyzes the driving behavior data, the vehicle state data, the road environment data, the surrounding traffic situation data, and the AI control algorithm behavior data using a time-series data generation model, an image generation model, an abnormality detection model, a multimodal AI model, and the like, integrally evaluates various risk factors, such as when AI overrides occur frequently, when LIDAR or camera abnormalities occur frequently, when there are many AI judgment mistakes in bad weather or a congested environment, when there are many sudden accelerations/decelerations or sudden steerings, when signal or sign recognition failures continue, and when abnormal behavior increases after a version upgrade of the AI algorithm, and dynamically generates a risk score for each vehicle. The generative AI also accumulates past accident data and operation history data in a long-term memory unit, immediately issues a warning when a similar risk pattern appears, and automatically corrects a risk evaluation model. Based on the risk score of an evaluation unit, an insurance premium calculation unit automatically adjusts an autonomous driving AI insurance premium or a safety score according to a risk profile for each vehicle, such as applying a 30 percent discount from a basic insurance premium when the risk score is less than a certain value, and applying a surcharge when the risk score is high. An incentive providing unit automatically provides a discount incentive when safe driving or high-quality AI control continues for a certain period of time, immediately applies a surcharge when an abnormality or an accident occurs, and promotes improvement of the AI algorithm and optimization of a maintenance plan. A smart contract processing unit automates a settlement process of an insurance contract and an incentive providing process, automatically starts an insurance payout process when an accident occurs, and immediately recalculates an insurance premium when an abnormality in AI control is detected. A user interface unit displays a current risk score, a fluctuation status of the insurance premium, an acquisition status of a safe driving incentive, a past operation history, safe driving advice by the AI, and the like on a dashboard or a management screen for an operation manager or an AI developer, displays a warning message such as “The risk score is increasing because there are many LIDAR abnormalities” when LIDAR abnormalities occur frequently, and provides a notification such as “The insurance premium will be surcharged because human intervention from AI control occurs frequently” when AI overrides occur frequently. A corporate management dashboard unit provides a dashboard capable of collectively managing risk scores and insurance premiums of a plurality of vehicles, visualizes a driving tendency and a risk factor for each vehicle, grasps a risk trend for each specific vehicle or AI version, and can be utilized for an update of the AI algorithm and a maintenance plan. A data standardization unit standardizes Telematics data compliant with an ISO standard and heterogeneous data from a plurality of sensor platforms, and the generative AI automatically standardizes and normalizes the data even if the data is from different vehicle models or different sensor manufacturers, thereby maintaining accuracy of the risk evaluation model. Specifically, the present system adopts a distributed processing architecture in which an edge device and a cloud server cooperate. The present multimodal artificial intelligence model operates on the cloud server. The present multimodal artificial intelligence model includes a cross-attention mechanism that simultaneously processes data of a plurality of different modalities. The present multimodal artificial intelligence model receives an image tensor as an input. The present image tensor is, for example, an RGB array of 1920 pixels by 1080 pixels by 3 channels. The present multimodal artificial intelligence model receives time-series sensor data as an input. The present time-series sensor data is, for example, a 10-dimensional vector array for 100 steps sampled at 100 hertz. The present multimodal artificial intelligence model receives vehicle control data as an input. The present vehicle control data is, for example, a one-dimensional array including a steering angle and a brake pedal force. The present multimodal artificial intelligence model converts each input data into a feature vector by a dedicated encoder network. The present multimodal artificial intelligence model combines an image feature vector, a time-series feature vector, and a control feature vector. The present multimodal artificial intelligence model executes a self-attention operation on the combined feature vector. The present multimodal artificial intelligence model extracts a hidden correlation between respective modalities. The present multimodal artificial intelligence model generates an occurrence probability distribution of each risk factor as an output. The present occurrence probability distribution is a group of output values of a softmax function, such as a collision risk being 0.8 and a sensor abnormality risk being 0.9, for example. The present multimodal artificial intelligence model calculates a comprehensive risk score as an output. The present risk score is, for example, a continuous value from 0 to 100. The present system transfers the calculated risk score to a subsequent insurance premium calculation module or warning generation module in real time. The present system includes a vector database as the long-term memory unit. The present system indexes past accident data and abnormal behavior data as high-dimensional vectors in the vector database. The present system calculates a cosine similarity between the feature vector generated from current input data and a past vector in the vector database. The present system determines that it matches a past accident pattern when the similarity exceeds a predetermined threshold. The present system immediately issues a warning signal based on a determination result. The present system finely adjusts a weight parameter of the risk evaluation model online using an error backpropagation method. The present processing method is different from a conventional rule-based determination depending on single sensor data. The present processing method realizes fusion of a plurality of sensors by a cross-attention mechanism in a high-dimensional space. The present processing method dramatically improves robustness against individual sensor noise. The present processing method brings about a technical effect of dramatically improving accuracy of risk prediction in a complex traffic environment. The present system provides extremely high safety and economic rationality in a specific use case of real-time risk evaluation and dynamic insurance premium calculation of an autonomous driving taxi at a complex intersection in an urban area or in bad weather.

Specific examples of a prompt sentence to be read by the generative AI include “Calculate a risk score for each vehicle and extract an abnormality and a risk factor from the following time-series driving data, LIDAR abnormality, camera abnormality, AI override, weather, road surface condition, traffic density, signal recognition failure, sign recognition failure, version information of an AI algorithm, and the like” and “Estimate an abnormal behavior of AI control and an environmental risk from an in-vehicle camera image and sensor data, and reflect them in insurance premium calculation”. Specifically, the present prompt generation unit executes a dynamic template engine. The present system utilizes a large language model as an inference engine. The present large language model is a transformer-based deep learning network having tens of billions of parameters. The present prompt generation unit converts structured data extracted from a database into a natural language text format. The present structured data is, for example, a set of key-value pairs described in a JSON format. The present prompt generation unit combines a system prompt and the converted text data to generate an input token sequence. The present input token sequence is a one-dimensional integer array obtained by tokenizing a character string such as “Input data: speed 60 km, weather rain, LIDAR abnormality twice. Instruction: calculate a risk score and specify a main factor”, for example. The present large language model receives the input token sequence. The present large language model calculates a contextual dependency between tokens using a self-attention mechanism. The present large language model predicts an appearance probability distribution of a next token. The present large language model autoregressively generates a text token based on the predicted probability distribution. The present large language model generates a structured text of a risk analysis result as an output. The present output data is text data in a JSON format such as “Risk score: 85, Main factor: poor visibility due to LIDAR abnormality in rainy weather, Recommended action: 10 percent surcharge of insurance premium and inspection of sensor”, for example. The present system parses the output text data. The present system automatically transmits the extracted risk score and recommended action to a subsequent insurance premium update process or maintenance arrangement system. The present processing method is different from a fixed conditional branching script defined in advance by a human. The present processing method utilizes a zero-shot inference capability of a natural language processing model. The present processing method flexibly interprets and evaluates even an unknown complex risk event that is difficult to deal with on a rule basis. The present processing method brings about a technical effect of ensuring transparency of a judgment basis of the artificial intelligence by converting a complex event into a language expression understandable by a human. The present system dramatically improves business efficiency and evaluation accuracy in a specific use case of an automatic risk report generation system for an assessment person in charge of an insurance company or a real-time decision-making support system for an operation manager.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

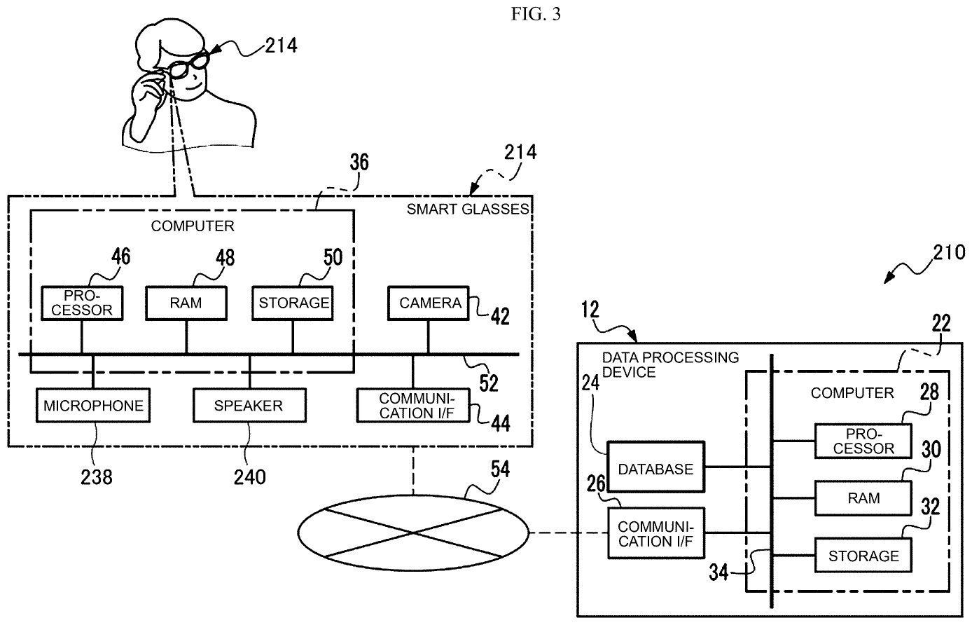

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

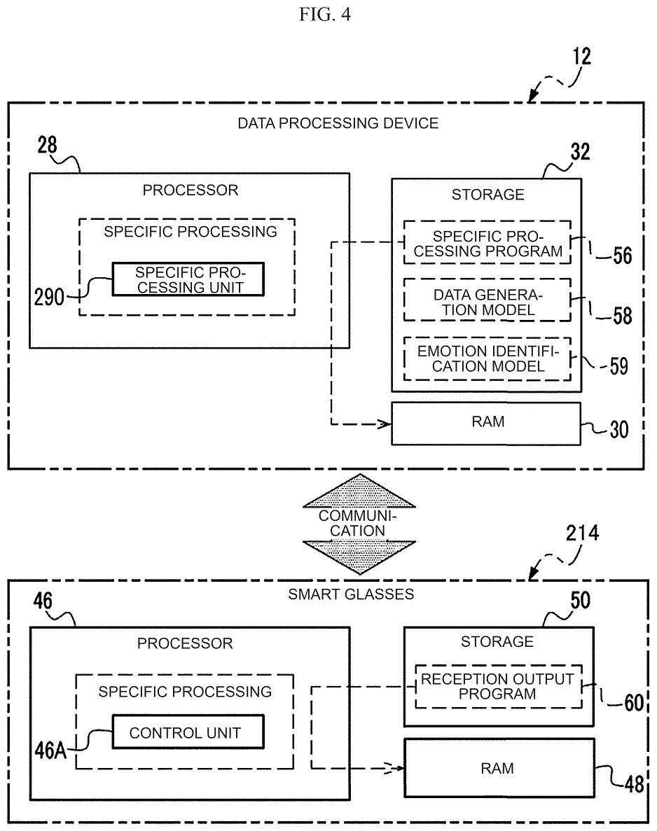

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

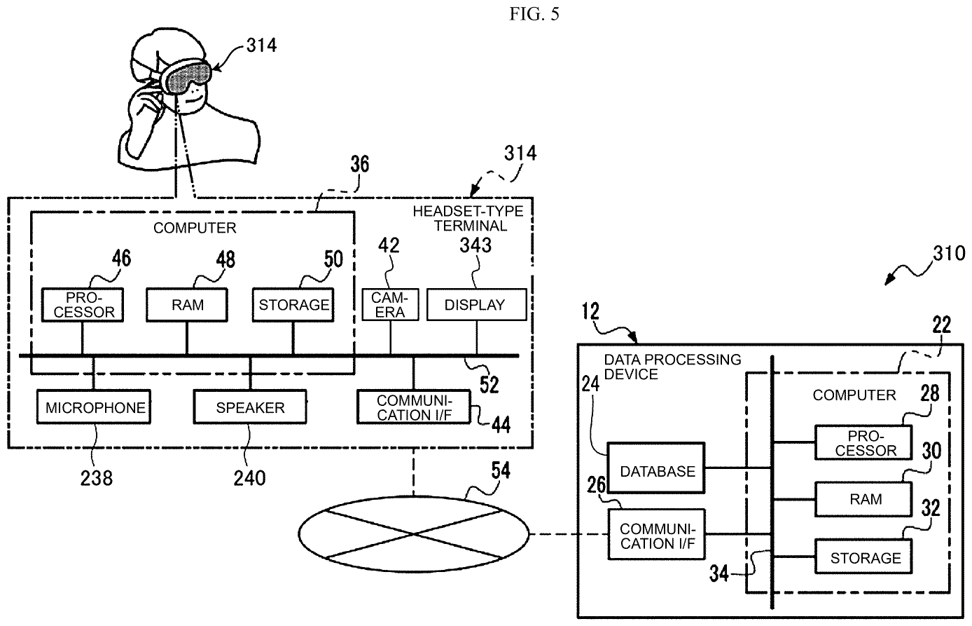

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

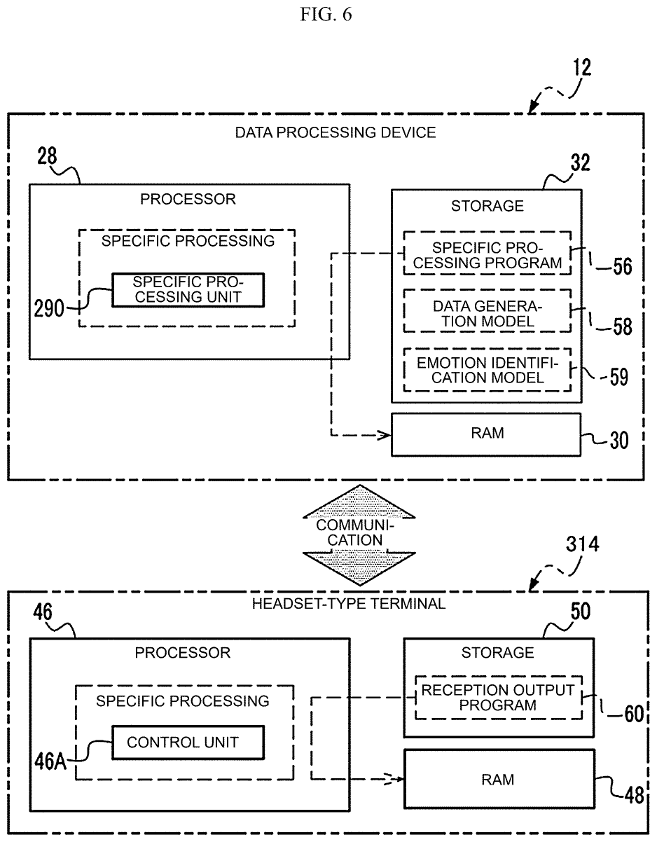

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

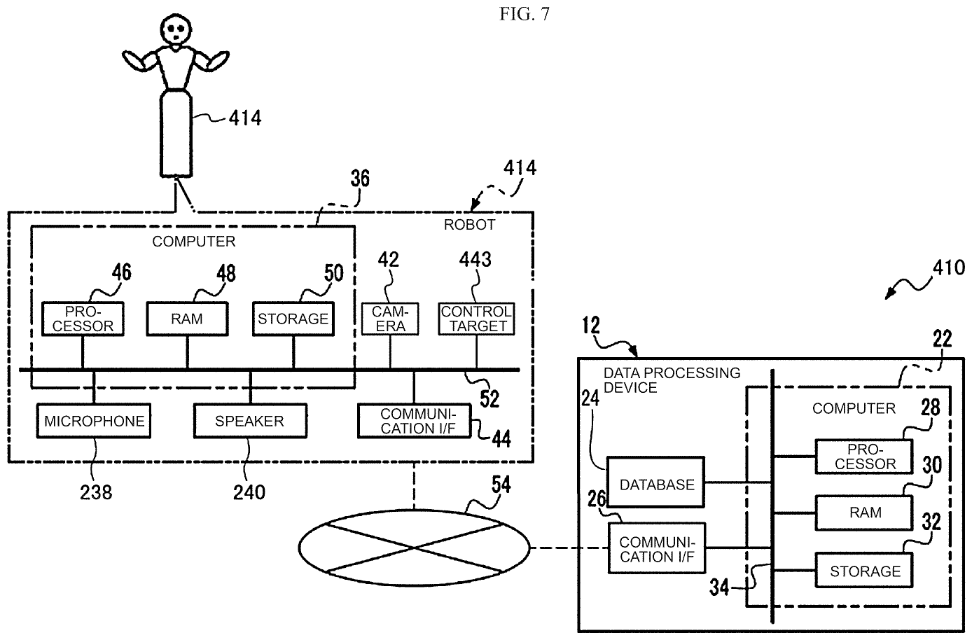

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

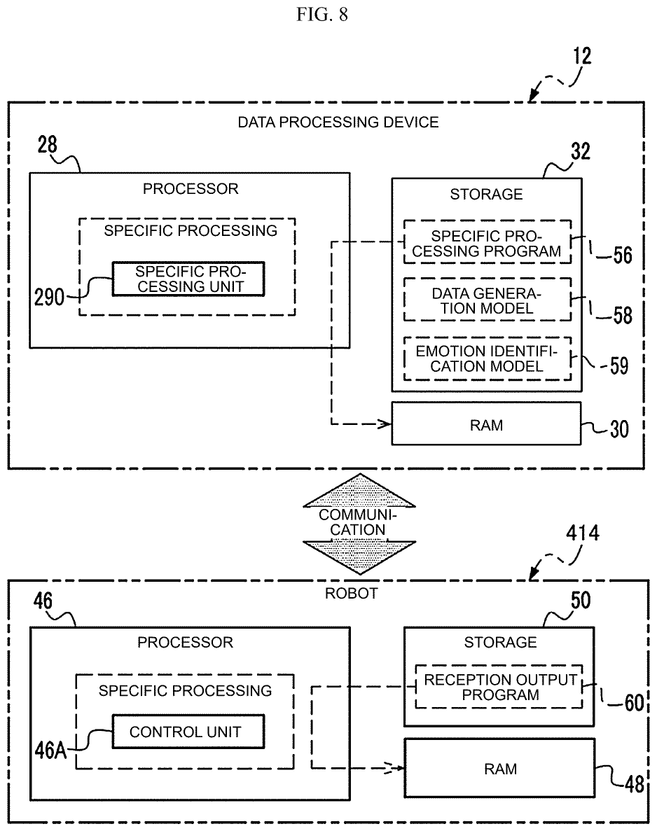

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

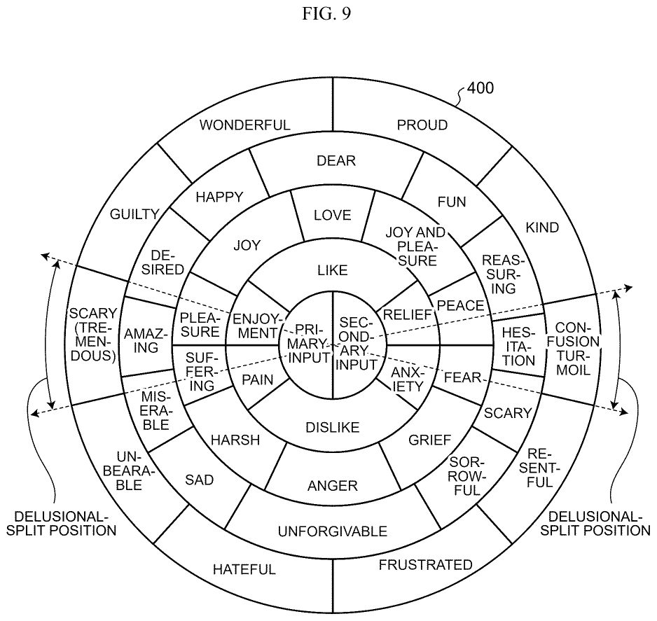

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

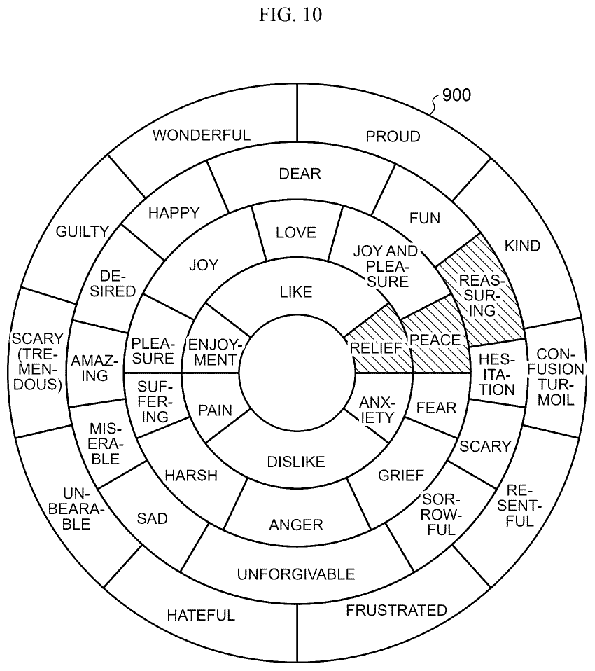

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A risk evaluation and insurance premium dynamic calculation system for autonomous vehicles using generative AI, comprising: a data acquisition unit configured to collect driving behavior data, vehicle state data, road environment data, surrounding traffic situation data, and AI control algorithm behavior data acquired from an autonomous vehicle; an evaluation unit configured to analyze a plurality of types of data obtained from the data acquisition unit in real time and multilaterally by a generative AI, and quantitatively evaluate a risk of an autonomous driving AI; and an insurance premium calculation unit configured to accumulate risk evaluation results by the evaluation unit and past operation history data over a long period of time, dynamically calculate an autonomous driving AI insurance premium or an autonomous driving AI safety score based on a risk evaluation model continuously optimized by a machine learning model, and automatically apply a discount or surcharge incentive according to a risk profile for each vehicle, wherein the evaluation unit is configured to multilaterally analyze a plurality of risk factors such as speeding, sudden acceleration/deceleration, sudden steering, LIDAR abnormality, camera abnormality, human intervention from AI control, bad weather, bad road surface, and high traffic density; and the insurance premium calculation unit is configured to calculate an insurance premium or a safety score according to an autonomous driving AI risk that fluctuates in real time, and further automate a settlement process of an insurance contract using a smart contract technology.

### (Supplementary Note 2)

The system according to Supplementary Note 1, wherein the evaluation unit is configured to standardize Telematics data compliant with an ISO standard and heterogeneous data acquired from a plurality of sensor platforms, and execute highly accurate data analysis by the generative AI, thereby improving risk evaluation accuracy for each autonomous driving AI; and the insurance premium calculation unit is configured to automatically provide a discount incentive for promoting operation quality and safety improvement.

### (Supplementary Note 3)

The system according to Supplementary Note 1, wherein the evaluation unit is configured to accumulate past accident data and operation history data as a long-term memory; the machine learning model by the generative AI is configured to continuously correct and optimize the risk evaluation model by adapting to a new operation pattern and an environmental change; and the insurance premium calculation unit is configured to automatically optimize an insurance premium structure or a safety score structure so as to achieve both a reduction in an insurance payout amount and optimization of an operation management cost.

What is claimed is:

1. A system comprising:
circuitry configured to:
receive, via a communication interface coupled to a packet-switched network, multidimensional sensor data from a plurality of sensor devices installed on a vehicle, the multidimensional sensor data comprising acceleration values, angular velocity values, geographic coordinate values, three-dimensional point cloud data from a light detection and ranging sensor, image tensor data from a camera sensor, and vehicle system state parameters from a controller area network bus interface, and store the received data in a storage device;
apply a multimodal sensor fusion model to the multidimensional sensor data to generate a fused state representation vector, and apply a deep learning model to the fused state representation vector to compute a risk score vector comprising risk probability values for a plurality of risk event categories;
accumulate the risk score vector in a longitudinal driving record data structure in the storage device, apply a machine learning model to the longitudinal driving record data structure to generate a risk profile data record, and dynamically update the risk profile data record based on the accumulated risk score vectors; and
generate a personalized parameter adjustment data record from the risk profile data record using a continuously optimized risk evaluation model, and transmit the personalized parameter adjustment data record to the terminal device via the communication interface.

2. The system according to claim 1, wherein the circuitry is configured to receive acceleration values, angular velocity values, and vehicle heading data from inertial measurement unit sensors and global positioning system receivers at a predetermined sampling rate, apply a Kalman filter to the received sensor values to fuse inertial and position measurements, and generate a smoothed trajectory data record.

3. The system according to claim 2, wherein the circuitry is configured to apply the multimodal sensor fusion model by encoding each sensor modality with a dedicated modality-specific encoder, integrating the encoded feature vectors in a cross-attention fusion layer, and generating the fused state representation vector from the integrated cross-attention output.

4. The system according to claim 1, wherein the circuitry is configured to process three-dimensional point cloud data from the light detection and ranging sensor to detect surrounding object positions, velocities, and trajectories, apply an object classification model to classify detected objects by type, and incorporate object position and velocity data as contextual features in the fused state representation vector.

5. The system according to claim 4, wherein the circuitry is configured to apply a convolutional neural network to image tensor data from the camera sensor to extract visual scene feature vectors, fuse the visual scene feature vectors with the point cloud object detection features and the inertial sensor data in the cross-attention fusion layer.

6. The system according to claim 1, wherein the circuitry is configured to apply the deep learning model to the fused state representation vector by computing risk probability values for each of a plurality of risk event categories comprising rapid deceleration events, lane departure events, and adverse condition navigation events, and aggregating the computed risk probability values into the risk score vector.

7. The system according to claim 6, wherein the circuitry is configured to apply a time-series aggregation model to accumulate risk score vectors over a configurable longitudinal time window, compute a trend metric for each risk event category by fitting a regression model to the accumulated risk score time series, and incorporate the trend metrics as additional features in the risk profile data record.

8. The system according to claim 1, wherein the circuitry is configured to acquire external condition data from external data service endpoints via the communication interface comprising weather condition values, road surface condition identifiers, and traffic density values, and incorporate the acquired external condition data as environmental context features in the fused state representation vector.

9. The system according to claim 1, wherein the circuitry is configured to apply a continuous optimization procedure to the risk evaluation model by generating training pairs from historical risk score vectors and corresponding validated outcome event records, and updating the risk evaluation model weights using a gradient descent procedure at configurable update intervals.

10. The system according to claim 1, wherein the circuitry is configured to generate a positive reinforcement indicator when the risk score vector remains below a low-risk threshold parameter for a configurable duration, incorporate the positive reinforcement indicator into the personalized parameter adjustment data record, and transmit the positive reinforcement indicator to the terminal device as a performance notification.

11. The system according to claim 1, wherein the circuitry is configured to generate a real-time risk indicator when an instantaneous risk score value exceeds a real-time alert threshold parameter, and transmit the real-time risk indicator to the terminal device via the communication interface for immediate driver notification.

12. The system according to claim 1, wherein the circuitry is configured to apply a scenario simulation model to the longitudinal driving record data structure to generate a projected risk trajectory under each of a plurality of simulated driving condition scenarios, and incorporate the projected risk trajectories as supporting data in the personalized parameter adjustment data record.

13. The system according to claim 1, wherein the circuitry is configured to aggregate risk profile data records across a plurality of vehicle identifiers to compute population-level risk distribution statistics, and apply the generative neural network model to generate a natural language insight report comparing an individual risk profile against population-level benchmarks.

14. The system according to claim 1, wherein the circuitry is configured to apply an in-vehicle biometric sensor data stream to the multimodal sensor fusion model as an additional input modality, compute a fatigue probability score from the biometric sensor data, and incorporate the fatigue probability score as an additional feature dimension in the fused state representation vector.

15. The system according to claim 1, wherein the circuitry is configured to store all multidimensional sensor data records, risk score vectors, and risk profile data records in an audit log data structure with timestamps and vehicle identifiers, and generate a performance history report for transmission to designated terminal devices.

16. The system according to claim 1, wherein the circuitry is configured to encrypt data transmissions between the vehicle sensor devices and the system using a transport layer security protocol, and authenticate the vehicle communication module using a digital certificate prior to accepting multidimensional sensor data for processing.

17. The system according to claim 1, wherein the sensor devices comprise inertial measurement units, a global positioning system receiver, a light detection and ranging sensor, a camera sensor, and a controller area network bus interface installed on a vehicle, and the risk score vector represents risk probability values for specific driving behavior categories computed from the multimodal sensor fusion model output.

18. A system comprising:
circuitry configured to:
receive, via a communication interface coupled to a packet-switched network, multidimensional sensor data from vehicle-mounted sensors comprising inertial measurement units, a light detection and ranging sensor, a camera sensor, and a controller area network bus interface;
apply a multimodal sensor fusion model with a cross-attention fusion layer to generate a fused state representation vector, and apply a deep learning model to compute a risk score vector;
accumulate risk score vectors in a longitudinal driving record, apply a machine learning model to generate and dynamically update a risk profile data record, and apply a continuous optimization procedure to the risk evaluation model; and
generate a personalized parameter adjustment data record and transmit it to terminal devices via the communication interface.

19. The system according to claim 18, wherein the circuitry is configured to apply external condition data from weather and traffic services as environmental context features in the fused state representation vector, apply a scenario simulation model to generate projected risk trajectories under simulated driving conditions, and aggregate risk profile data across multiple vehicle identifiers to generate population-level benchmark comparisons.

20. A method comprising:
receiving, via a communication interface coupled to a packet-switched network, multidimensional sensor data from a plurality of sensor devices on a vehicle comprising acceleration values, angular velocity values, geographic coordinate values, three-dimensional point cloud data, and vehicle system state parameters, and storing the data in a storage device;
applying a multimodal sensor fusion model to generate a fused state representation vector, and applying a deep learning model to compute a risk score vector;
accumulating risk score vectors in a longitudinal driving record data structure, and applying a machine learning model to generate and update a risk profile data record; and
generating a personalized parameter adjustment data record from the risk profile data record and transmitting it to a terminal device via the communication interface.
